(19) United States
(12) Patent Application Publication
(10) Pub. No.: US 2006/0244870 A1
(43) Pub. Date: Nov. 2, 2006

(54) Mounting mechanism and monitor mounting apparatus

(75) Inventors: Norihiko Yamato, Saitama (JP); Ichiro Katagiri, Tokyo (JP); Yoshio Kajino, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-Ku (JP)

(21) Appl. No.: 11/404,090

(22) Filed: Apr. 14, 2006

(30) Foreign Application Priority Data
Apr. 28, 2005 (JP) 2005-132322

(51) Int. Cl. H04N 5/64

(52) U.S. Cl. 348/836

(57) ABSTRACT

A mounting mechanism provided in a predetermined movable member for mounting an object on the member includes a fixing unit configured to fix the object to the member in drivingly associated with a change in position of the member, and the fixing unit is configured to have a hook with a hook-like end and to rotate the hook in drivingly associated with a change in position of the member so as to fix the object at a predetermined position using the hook-like shape of the hook end.

### CROSS REFERENCES TO RELATED APPLICATIONS

The present invention contains subject matter related to Japanese Patent Application JP 2005-132322 filed in the Japanese Patent Office on Apr. 28, 2005, the entire contents of which are incorporated herein by reference.

### BACKGROUND OF THE INVENTION

1. Field of the Invention

The present invention relates to a mounting mechanism and a monitor mounting apparatus, and in particular relates to a mounting mechanism and a monitor mounting apparatus capable of mounting a plurality of monitors, of which a user can easily mount or remove an arbitrary monitor.

2. Description of the Related Art

There have been methods, in which a large number of television receivers have been used by connecting them to each other so as to achieve advanced capabilities in comparison with when used as elementary substances (see Japanese Unexamined Patent Application Publication No. 2003-195843, for example). In a scalable TV system using such a method, one picture may be displayed using all the displays of the television receivers connected together (all the displays may be used as one picture); the same picture may be displayed on each display; static images captured from the same moving picture at timings different from each other (the continuous image expressed by a plurality of static images) may be displayed on the respective monitors; and programs of channels different from each other may be simultaneously displayed.

Also, there have been methods using peculiar parts for stably mounting the television receivers. Such peculiar parts may include a rack as a shelf for placing the television receivers thereon and a wall-hanging hook for hanging the television receiver as well as a stand for placing the television receiver thereon so as to have a preferable height (position) of the television receiver.

Such a stand (display stand) may include a movable stand capable of changing a mounting direction of the display mounted thereon (see Japanese Unexamined Patent Application Publication No. 2004-191601, for example). This display stand includes a movable arm so as to fix the back of the display with this arm. The display can be thereby changed in direction and position within a movable range of the arm. By providing a plurality of the arms, this display stand can mount a plurality of displays thereon.

### SUMMARY OF THE INVENTION

However, when all the displays are used as one display so as to display one picture by operating a plurality of the television receivers in cooperation with each other as mentioned above, and if the displays of the television receivers are apart to each other so that a space between the displays is large, the one displayed picture may not be shown as one image. Namely, if the television receivers are apart to each other, a user may be difficult to see the image. Hence it is preferable that the television receivers be arranged by bringing them as close to each other as possible.

However, in the method using the arm mentioned above, because there is no clearance between sides of displays, which are arranged in a matrix with border on touch each other, especially in the vicinity of the arrangement center, where being surrounded by other displays, it may be difficult for a user to detach or attach the display as a hand or finger cannot be inserted into the clearance.

In particular, in the scalable TV system disclosed in Japanese Unexamined Patent Application Publication No. 2003-195843, it is supposed that not only a plurality of the television receivers are used by connecting them to each other but also each television receiver is used individually. In such a scalable TV system, detachment/attachment (replacement) of the television receiver from/to the stand may be frequently performed; however, if a user may not replace the television receiver easily as mentioned above, the user-friendliness of the system may be deteriorated.

The present invention has been made in view of such a situation, and it is desirable to arrange a plurality of monitors so that a user may easily mount or remove an arbitrary arranged monitor.

A mounting mechanism provided in a predetermined movable member for mounting an object on the member according to an embodiment of the present invention includes fixing means for fixing the object to the member in drivingly associated with a change in position of the member.

Preferably, the fixing means includes a hook with a hook-like end, and rotates the hook in drivingly associated with a change in position of the member so as to fix the object at a predetermined position using the hook-like shape of the hook end.

Preferably, the mounting mechanism further includes an immovable fixed member, and the member is connected to the fixed member with a pantograph mechanism therebetween so as to slide in back and forth directions relative to the fixed member within a movable range of the pantograph mechanism, and the fixing means changes the state of the object to be mountable when the member is forward slid, and it mounts the object arranged at a predetermined position on the member when the member is rearward slid.

Preferably, when the member is rearward slid, if the object is not arranged at a predetermined position, the fixing means is accommodated within the member.

A monitor mounting apparatus for stably mounting a monitor on a movable member according to an embodiment of the present invention includes a fixed member; and the movable member movably connected to the fixed member, and the movable member includes monitor fixing means for fixing the monitor to the movable member in drivingly associated with a change in position of the movable member relative to the fixed member.

In the mounding mechanism according to an embodiment of the present invention, the object is fixed on the member in drivingly associated with a change in position of the member.

In the monitor mounting apparatus according to an embodiment of the present invention, the monitor is fixed on the movable member in drivingly associated with a change in position of the movable member relative to the fixed member.

A mounting mechanism provided in a predetermined movable member for mounting an object on the member according to an embodiment of the present invention includes a fixing unit configured to fix the object to the member in drivingly associated with a change in position of the member, and the fixing unit is configured to have a hook with a hook-like end and to rotate the hook in drivingly associated with a change in position of the member so as to fix the object at a predetermined position using the hook-like shape of the hook end.

### BRIEF DESCRIPTION OF THE DRAWINGS

FIG. 1 is a drawing of a stand for mounting a scalable TV system according to an embodiment of the present invention;

FIG. 2 is a right side view of the stand shown in FIG. 1;

FIG. 3 is a drawing showing the situation of the stand;

FIG. 4 is a perspective view showing a detailed structure of a mounting unit;

FIG. 5 is a perspective view showing a detailed structure of the mounting unit;

FIG. 6 is a side view of the mounting unit;

FIG. 7 is a perspective view of a back face of the television receiver;

FIG. 8 is a drawing showing the forward slid mounting unit;

FIG. 9 is a drawing showing the rearward slid mounting unit having the television receiver mounted thereon;

FIG. 10 is a drawing showing the mounting unit without the television receiver which has been removed;

FIG. 11 is a drawing for illustrating the situation of the rearward fixed mounting unit;

FIG. 12 is a perspective view of the detailed structure of a monitor hook;

FIG. 13 is a perspective view of the detailed structure of the monitor hook;

FIG. 14 is a drawing showing the structure of a link:

FIG. 15 is a side perspective view of a monitor hook;

FIG. 16 is a side perspective view of the monitor hook;

FIG. 17 is a side perspective view of the monitor hook;

FIG. 18 is a side perspective view of the monitor hook;

FIG. 19 is a side perspective view of the monitor hook;

FIG. 20 is a side perspective view of the monitor hook;

FIG. 21 is a side perspective view of the monitor hook;

FIG. 22 is a side perspective view of the monitor hook;

FIG. 23 is a side perspective view of the monitor hook;

FIG. 24 is a side perspective view of the monitor hook;

FIG. 25 is a side perspective view of the monitor hook;

FIG. 26 is a side perspective view of the monitor hook;

FIG. 27 is an explanatory view of a connector;

FIG. 28 is a perspective view of the connector;

FIG. 29 is a perspective view of the connector viewed from the side of the stand;

FIG. 30 is a drawing of the configuration of an electric circuit;

FIG. 31 is a perspective view of the stand viewed from the upside;

FIG. 32 is a perspective view of the stand viewed from the lower rear;

FIG. 33 shows a different state of the monitor lock;

FIG. 34 is an explanatory view of the structure of the body of the stand;

FIG. 35 is a front view of the stand;

FIG. 36 is a perspective view of the mounting unit and the body of the stand viewed from the upside;

FIG. 37 is a perspective view of the mounting unit and the body of the stand viewed from the upside;

FIG. 38 is a perspective view of the mounting unit and the body of the stand viewed from the upside;

FIG. 39 is a perspective view of the mounting unit and the body of the stand viewed from the upside;

FIG. 40 is a perspective view of the mounting unit and the body of the stand viewed from the upside;

FIG. 41 is a perspective view of the mounting unit and the body of the stand viewed from the upside;

FIG. 42 is a perspective view of the mounting unit and the body of the stand viewed from the upside; and

FIG. 43 is a perspective view of the mounting unit and the body of the stand viewed from the upside.

### DESCRIPTION OF THE PREFERRED EMBODIMENTS

Embodiments of the present invention will be described below; and the correspondence relationship between the inventions of this specification and the embodiment of the invention is as follows. This description is for confirming that embodiments supporting inventions of Claims are included in the specification. Accordingly, even if there are items not corresponding to the invention but to be described in an embodiment, this does not mean that the embodiment does not correspond to the invention. Conversely, even if an embodiment is described in the specification to correspond to the invention, this does not mean that the embodiment does not correspond to inventions other than the invention.

Furthermore, this does not mean all the inventions described in the specification. In other words, this description includes the inventions described in this specification, and it does not deny the existence of inventions not being claimed in this application, i.e., inventions which will be divisionally applied or added as amendment in future.

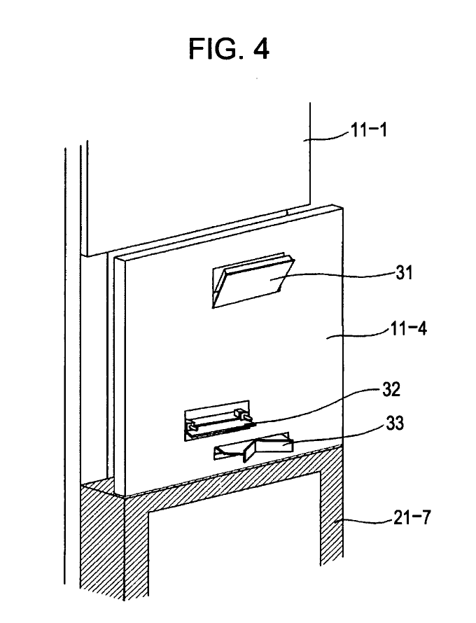

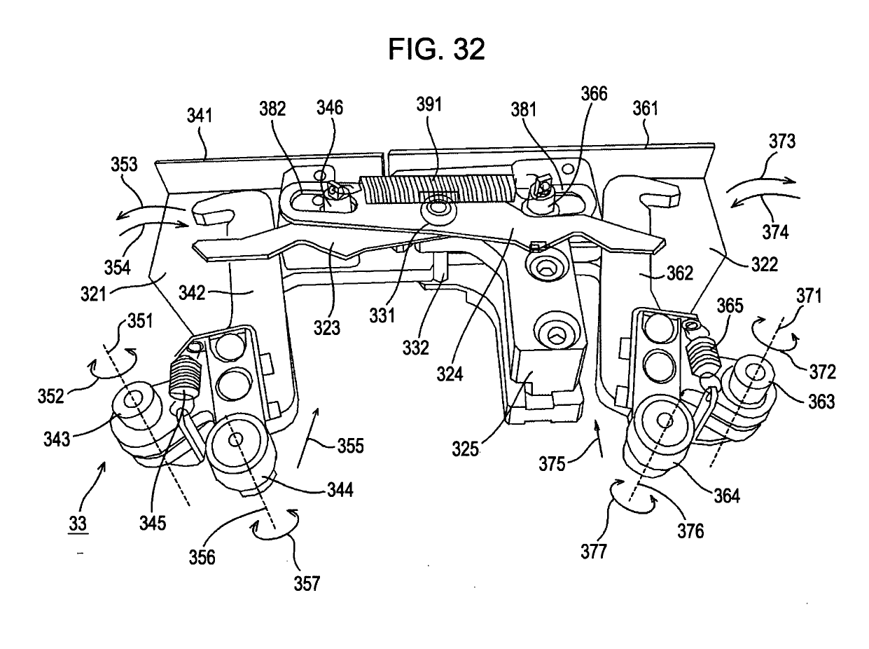

According to an embodiment of the present invention, there is provided a mounting mechanism (a monitor lock shown in FIG. 4, for example) arranged in a predetermined movable member for fixing an object to the member. The mounting mechanism includes fixing means (a left base plate, a right base plate, and hooks shown in FIG. 32, for example) for fixing the object to the member in drivingly associated with a change in position of the member.

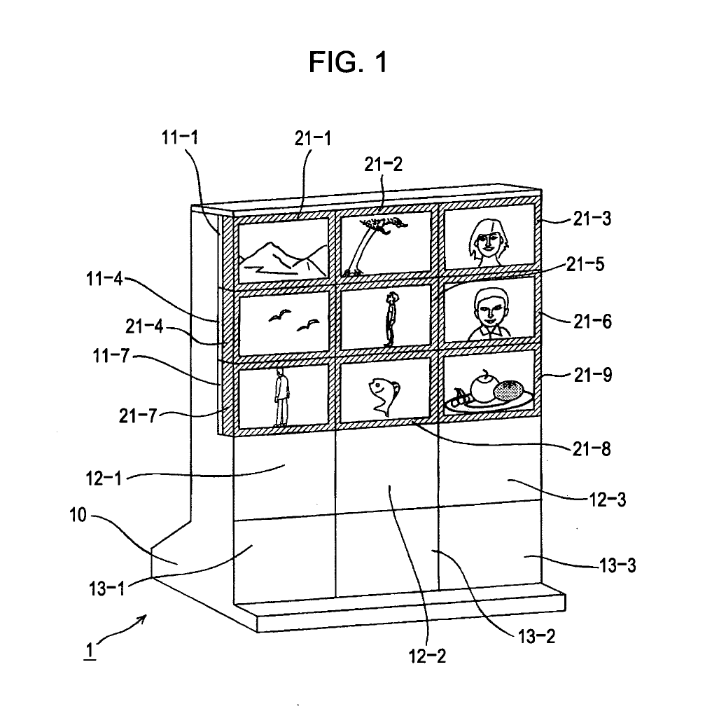

According to an embodiment of the present invention, there is provided a monitor fixing device (a stand shown in FIG. 1, for example) having a fixed member and a movable member (a mounting unit of FIG. 1, for example) movably connected to the fixed member for stably fixing a monitor (a TV receiver of FIG. 1, for example) to the movable member. The monitor fixing device includes monitor fixing means (a monitor lock shown in FIG. 4, for example) for fixing the monitor to the movable member in drivingly associated with a change in position of the movable member relative to the fixed member.

Embodiments of the present invention will be described below with reference to the drawings.

FIG. 1 is a drawing showing a stand for mounting a scalable television system thereon according to an embodiment of the present invention.

Referring to FIG. 1, a stand 10 is an installation member (or accommodation member) for stably setting a scalable television system 1 (referred to as a scalable TV system 1 below) thereon.

The scalable TV system 1 includes nine television receivers 21-1 to 21-9 so as to achieve advanced capabilities by operating in cooperation with each other or individually in comparison with a single television. The television receivers 21-1 to 21-9 will be referred to as the television receivers 21 below unless individually specified.

For example, in the scalable TV system 1, by operating the television receivers 21 in cooperation with each other, all the displays are used as one screen so as to display one picture, different pictures are displayed only on some displays, different channel broadcast programs are displayed on the respective displays, or static images associated with each other such as a continuous image are displayed. The respective television receivers 21 can also be individually operated. The number of the television receivers 21 coordinating as the scalable TV system 1 is not necessarily nine but it may be any number as long as it is two or more.

The stand 10 is a setting member (monitor fixing device or fixing mechanism) for stably setting the television receivers 21 (monitors or displays) constituting the scalable TV system 1 thereon. That is, the stand 10 includes mounting units 11-1 to 11-9 for mounting the nine television receivers 21. Each of the television receivers 21 is mounted on the respective mounting units 11-1 to 11-9. The mounting units 11-1 to 11-9 will be referred to as the mounting units 11 below unless individually specified.

In FIG. 1, only the mounting units 11-1, 11-4, and 11-7 are shown and others are omitted. The nine mounting units 11 are arranged in a matrix form of 3×3 in FIG. 1. That is, the mounting unit 11-1 is arranged on the utmost upper left; the mounting unit 11-2 toward the right adjacent to the mounting unit 11-1; further the mounting unit 11-3 toward the right adjacent to the mounting unit 11-2; the mounting unit 11-4 below the mounting unit 11-1; the mounting unit 11-5 toward the right adjacent to the mounting unit 11-4; further the mounting unit 11-6 toward the right adjacent to the mounting unit 11-5; the mounting unit 11-7 below the mounting unit 11-4; the mounting unit 11-8 toward the right adjacent to the mounting unit 11-7; and further the mounting unit 11-9 toward the right adjacent to the mounting unit 11-8. On the mounting units 11-1 to 11-9, the television receivers 21-1 to 21-9 are mounted, respectively. In practice, the respective television receivers 21 have functions to comprehend their mounted position, so that the television receivers 21 may be mounted on any of the mounting units 11; however, the television receivers 21 are to be mounted herein on the mounting units 11 in a sequential order shown in FIG. 1 for descriptive convenience sake.

That is, on the stand 10, the nine television receivers 21 are arranged on one plane in a matrix form of 3×3, so that the television receiver 21-1 is arranged and fixed on the utmost upper left; the television receiver 21-2 toward the right adjacent to the television receiver 21-1; further the television receiver 21-3 toward the right adjacent to the television receiver 21-2; the television receiver 21-4 below the television receiver 21-1; the television receiver 21-5 toward the right adjacent to the television receiver 21-4; further the television receiver 21-6 toward the right adjacent to the television receiver 21-5; the television receiver 21-7 below the television receiver 21-4; the television receiver 21-8 toward the right adjacent to the television receiver 21-7; and further the television receiver 21-9 toward the right adjacent to the television receiver 21-8.

As will be described later, the stand 10 has a function to connect the television receivers 21 to each other, so that the television receivers 21 connected to each other via the stand 10 operate as the scalable TV system 1. Also, the mounting units 11 are movable members so as to slide independently on each other and back and forth during attaching and detaching the television receivers 21, as will be described later.

The surface of the stand 10 where the mounting units 11 are provided, i.e., the television receivers 21 are to be set, is defined below to be the front surface of the stand 10.

In the lower tier of the mounting units 11 of the stand 10, racks 12-1 to 12-3 are arranged in the horizontal direction. That is, as shown in FIG. 1, below the mounting unit 11-7, the rack 12-1 is provided; below the mounting unit 11-8, the rack 12-2; and below the mounting unit 11-9, the rack 12-3. The racks 12-1 to 12-3 will be referred to as the racks 12 below unless individually specified. The racks 12 are accommodation members for accommodating equipment inside or on the surface, such as speakers and an infrared light receiving section for a remote-controller (not shown), constituting the scalable TV system 1 other than the television receivers 21.

In the lowest tier of the mounting units 11 of the stand 10, i.e., in the tier below the racks 12, boxes 13-1 to 13-3 are provided. That is, as shown in FIG. 1, below the rack 12-1, the box 13-1 is provided; below the rack 12-2, the box 13-2; and below the rack 12-3, the box 13-3. The boxes 13-1 to 13-3 will be referred to as the boxes 13 below unless individually specified. The boxes 13 are partially or entirely hollow box-like casings for accommodating electric units inside, such as a power supply circuit for distributing electric power received from the outside to the television receivers 21 and a distributor for connecting the television receivers 21 set on the stand 10 to an antenna arranged outside the stand 10 for receiving a television broadcasting signal.

In the racks 12 and the boxes 13 of the stand 10, equipment other than the scalable TV system 1, such as a recorder, may also be provided.

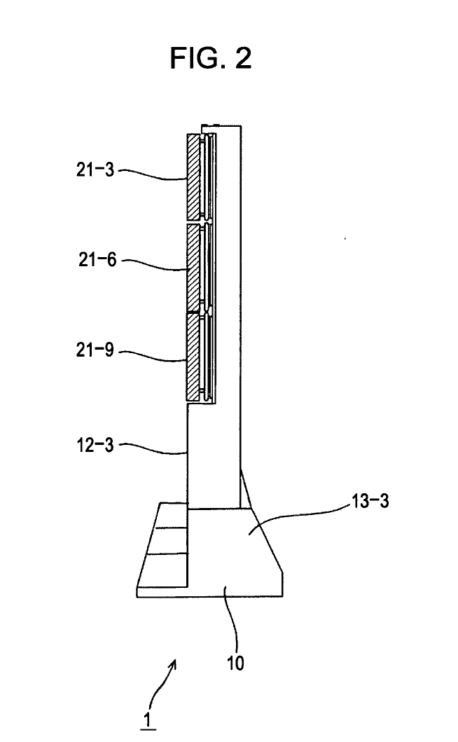

FIG. 2 is a side view of the stand 10 viewed from the right side (the television receiver 21-3, the television receiver 21-6, the television receiver 21-9, the rack 12-3, and the box 13-3) .

As shown in FIG. 2, the thickness of part of the mounting units 11 of the stand 10 is smaller than that of part of the racks 12 and the boxes 13, and the front surface (surface on which images are displayed) of the television receivers 21 provided on the stand 10 (in FIG. 2, the television receiver 21-3, the television receiver 21-6, and the television receiver 21-9) is substantially flush with those of the racks 12 and the boxes 13. In addition, in the stand 10, the front surface of the television receivers 21 may also not be flush with those of the racks 12 and the boxes 13.

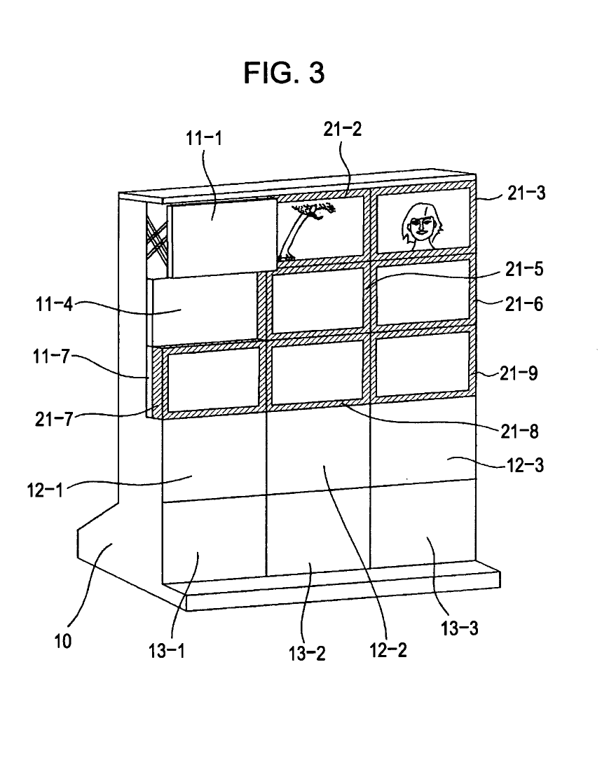

As shown in FIGS. 1 and 2, on the stand 10, the nine television receivers 21 are arranged in a matrix form roughly without clearance (to the extent that a user's hand cannot be inserted between the television receivers 21, for example). The stand 10 is constructed so that a user can easily put on or take off the television receivers 21 (so as to be detachable/attachable the television receivers 21 by a user). The mounting units 11, as shown in FIG. 3, can slide forward (in a perpendicular direction to the front face and separating therefrom) so that a user can easily grasp the side or the rear face of a television receiver 21 during putting/taking (detaching/attaching) the television receiver 21 on/off the stand 10.

FIG. 3 shows a situation of the stand 10 when the television receiver 21-1 and the television receiver 21-4 are detached from the mounting unit 11-1 and the mounting unit 11-4, respectively. Referring to FIG. 3, the mounting unit 11-1 is forward slid; and the mounting unit 11-4 is set at the same position as those of the other mounting units 11 having the television receivers 21 mounted thereon.

In the stand 10, a user can put/take (detach/attach) the television receiver 21 on/off any of the mounting units 11 in a forward sliding state in the same way as in the mounting unit 11-1. For example, upon completing setting, when the set television receivers 21 are to be operated as the scalable TV system 1, a user pushes the mounting units 11 (the television receivers 21 mounted on the mounting units 11) into the stand 10 so as to set them in the same state as in the mounting unit 11-7 (the television receiver 21-7) of FIG. 3. Also, when a television receiver 21 is detached off a mounting unit 11, a user pushes the mounting unit 11 into the stand 10 so as to set it in the same state as in the mounting unit 11-7 of FIG. 3 for moving it out of the way.

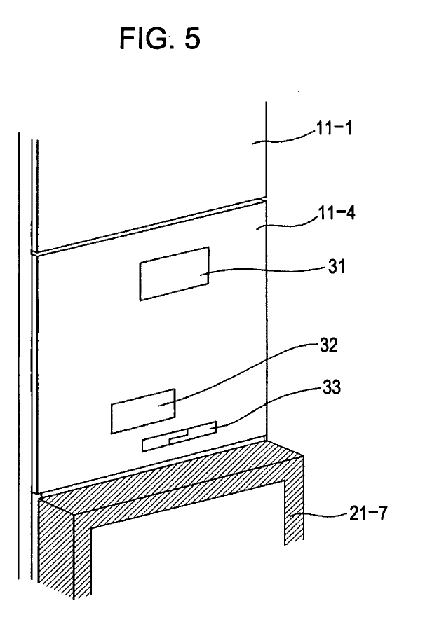

FIGS. 4 and 5 are perspective views of the mounting unit 11 showing its detailed structure; FIG. 4 shows that the mounting unit 11-4 is forward slid; and FIG. 5 shows that the mounting unit 11-4 is set in the back. Neither in FIG. 4 nor in FIG. 5, the television receiver 21-4 is not mounted.

As shown in FIG. 4, on the front surface (where the television receiver 21-4 is mounted) of the mounting unit 11-4, there are provided a monitor hook 31 for hooking the television receiver 21-4, a connector 32 which is a terminal group to be electrically connected to the television receiver 21-4, and a monitor lock 33 for fixing the hooked television receiver 21-4.

The monitor hook 31, the connector 32, and the monitor lock 33 will be described later in detail. As shown in FIG. 4, when the mounting unit 11-4 is forward slid, the entire monitor hook 31, the connector 32, and the monitor lock 33 are forward protruded. For example, when the mounting unit 11-4 is forward slid, the monitor hook 31 protrudes so as to tilt the top forward as shown in FIG. 4, so that the television receiver 21-4 can be hooked thereon at its holding pipe. Also, when the mounting unit 11-4 is forward slid, as shown in FIG. 4, the connector 32 is rotated about a horizontal axis so as to protrude forward until when the top is horizontally shifted, so that the terminals are forward projected. Thereby, when the pipe of the television receiver 21-4 is hooked on the monitor hook 31, terminals provided in the television receiver 21-4 and corresponding to the terminals of the connector 32 agree with the terminals of the connector 32 so that the television receiver 21-4 is electrically connected to the mounting unit 11-4 (the stand 10). Furthermore, when the mounting unit 11-4 is forward slid, as shown in FIG. 4, horizontal both ends of the monitor lock 33 protrude like scissors (V-shape back down at the center), so that a hook is set to protrude for fixing the bottom of the television receiver 21-4.

When the mounting unit 11-4 is set in the back without the television receiver 21-4, as shown in FIG. 5, the monitor hook 31, the connector 32, and the monitor lock 33 are retracted to the back of the mounting unit 11-4, so that the front surface of the mounting unit 11-4 becomes flat without unevenness. That is, when the mounting unit 11-4 is backward slid from the state of FIG. 4, the top of the monitor hook 31, which has been tilted forward, is rotated to the back so as to be vertical. The front surface of the monitor hook 31 becomes part of the front surface of the mounting unit 11-4 in this state so as to be flush therewith. Also, when the mounting unit 11-4 is backward slid from the state of FIG. 4, the top of the connector 32, which has been tilted forward, is raised to the back so as to be vertical. The front surface of the connector 32 becomes part of the front surface of the mounting unit 11-4 in this state so as to be flush therewith. Furthermore, when the mounting unit 11-4 is backward slid from the state of FIG. 4, the horizontal both ends of the monitor lock 33, which have protruded like scissors, are backward rotated so that the scissors are opened. The front surface of the monitor lock 33 becomes part of the front surface of the mounting unit 11-4 in this state so as to be flush therewith.

That is, when the mounting unit 11-4 is forward slid, as shown in FIG. 4, the monitor hook 31, the connector 32, and the monitor lock 33 protrude forward so as to be ready to do respective functions. Conversely, as shown in FIG. 5, when the mounting unit 11-4 is backward slid without the television receiver 21-4, the monitor hook 31, the connector 32, and the monitor lock 33 are accommodated within the mounting unit 11-4 so that the front surface of the mounting unit 11-4 becomes substantially one plane.

The mounting unit 11-4 has been described with reference to FIGS. 4 and 5; the entire mounting units 11 have the same structure as that of the mounting unit 11-4. That is, each of the mounting units 11-1 to 11-9 is provided with the monitor hook 31, the connector 32, and the monitor lock 33 mentioned above so as to mount the television receivers 21 thereon using these components.

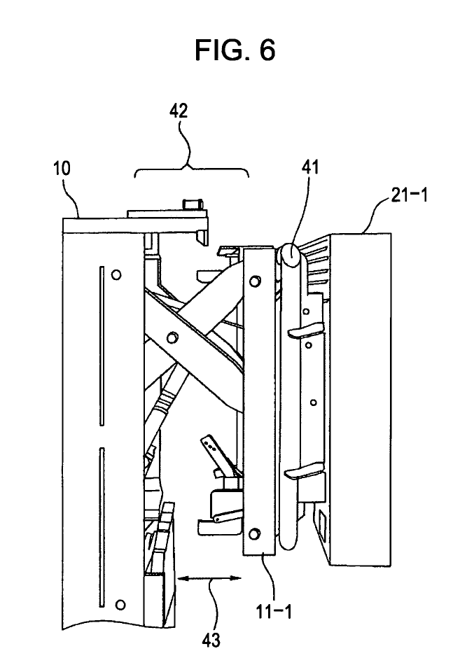

The mounting units 11, as shown in FIG. 6, are movably connected to the stand 10 using a pantograph mechanism composed of a plurality of arms combined. FIG. 6 is a side view of the mounting unit 11-1. Referring to FIG. 6, the television receiver 21-1 is fixed to the mounting unit 11-1 using a monitor pipe 41. The monitor pipe 41 is provided on the back surface (surface opposite to that where images are displayed) of the television receivers 21 to be gripped. When the television receiver is used as a single body, a user brings the television receiver 21 by gripping the monitor pipe 41. The monitor pipe 41 is also used for fixing the television receiver 21 to the mounting unit 11.

As will be described later, in the state shown in FIG. 6, the monitor pipe 41 is hooked at the monitor hook 31 of the mounting unit 11-1. At this time, the terminals of the connector 32 are electrically connected to the terminals of the television receiver 21-1. Also, in the state shown in FIG. 6, although the monitor lock 33 of the mounting unit 11-1 is protruded as shown in FIG. 4, its hook is not yet protruded, so that the bottom of the television receiver 21-1 is not fixed.

The mounting unit 11-1 is movably connected to the body of the stand 10 with a pantograph mechanism 42 composed of a plurality of arms assembled in an X-shape, so that the mounting unit 11-1 can slide back and forth relative to the stand 10 in double arrow 43 direction.

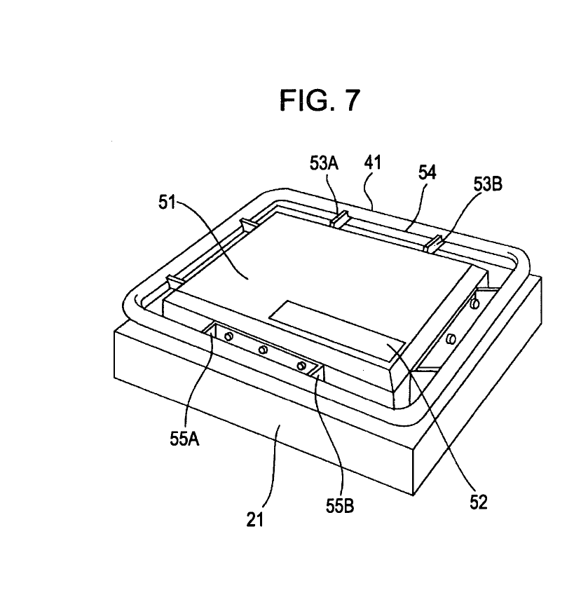

FIG. 7 is a perspective view illustrating the structure of the rear surface of the television receiver 21 to be mounted on the stand 10.

As shown in FIG. 7, on the rear surface of the television receiver 21, the monitor pipe 41 is connected with connection members therebetween. The material of the monitor pipe 41 may be any of a metal, such as stainless steel or aluminum, and plastics; it is preferable to be strong, light-weight, and low cost. The monitor pipe 41 is substantially rectangular and is formed by bending a cylindrical metal (pipe). The monitor pipe 41 is welded to predetermined connection members which are screwed to the television receiver 21 so as to fix the monitor pipe 41 thereto.

On the rear surface of the television receiver 21, an accommodation unit 51 is provided for accommodating an electric circuit, etc., therein. In the accommodation unit 51, a control unit, etc., is accommodated for operating the television receiver 21 as a television receiver. On part of the rear surface of the television receiver 21, a connector unit 52 is provided for accommodating an external terminal group. The terminals of the connector unit 52 include input and output terminals for various signals and further the terminals to be electrically connected to the terminals of the mounting unit 11 (the terminals of the connector 32).

As described with reference up to FIG. 6, during mounting the television receiver 21 on the stand 10 in the upper part of the monitor pipe 41, that is, the vicinity of a part 54 between connection members 53A and 53B, the television receiver 21 is hooked at the monitor hook 31. At this time, the connection members 53A and 53B are fixed to the mounting unit 11 by the hanging of the hook of the monitor lock 33.

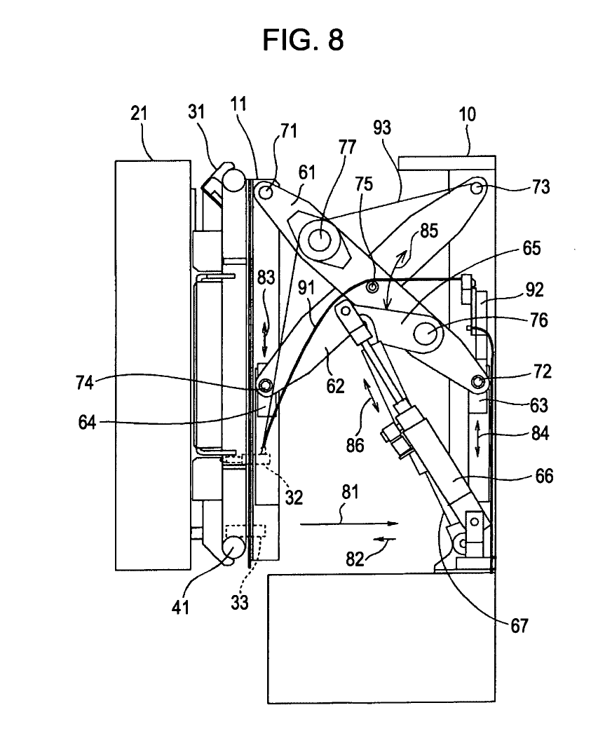

FIGS. 8 to 11 are drawings illustrating the sliding of the mounting unit 11 with and without the television receiver 21. FIG. 8 shows that the mounting unit 11 with the television receiver 21 is slid forward.

Referring to FIG. 8, the mounting unit 11 is connected to the body (column) of the stand 10 with long arms 61 and 62 constituting the pantograph mechanism 42 therebetween. The arm 61 and the arm 62 are connected together at the respective centers with a connection unit 75. The arm 61 can rotate around the arm 62 (the arm 62 around the arm 61) and about the connection unit 75. One end of the arm 61 is connected to the upper side face of the mounting unit 11 with a fixed end 71, and the other end is connected to an inner 63 arranged on a rail (not shown) with a fixed end 72. That is, the arm 61 is rotatable around the mounting unit 11 and about the connection end 71 while is rotatable around the inner 63 (the body of the stand 10, the column) and about the connection end 72.

Similarly, one end of the arm 62 is connected to the upper side face of the mounting unit 11 with a fixed end 73, and the other end is connected to an inner 64 arranged on a rail (not shown) with a fixed end 74. That is, the arm 62 is rotatable around the body of the stand 10 and about the connection end 73 while is rotatable around the inner 64 (the body of the stand 10, the column) and about the connection end 74.

The inner 63 is arranged on a rail (not shown) arranged on the lower side face of a part corresponding to the mounting unit 11 slidably and vertically as shown in double arrow 84. By the moving up and down of the inner 63, the space between the connection ends 72 and 73 is changed. That is, when the arm 61 is rotated around the arm 62 and about the connection end 75 (the arm 62 around the arm 61), the space between the connection ends 72 and 73 is changed by the sliding of the inner 63.

The inner 64 is arranged on a rail (not shown) arranged on the lower side face of a part corresponding to the mounting unit 11 slidably and vertically as shown in double arrow 83. By the moving up and down of the inner 64, the space between the connection ends 71 and 74 is changed. That is, when the arm 61 is rotated around the arm 62 and about the connection end 75 (the arm 62 around the arm 61), the space between the connection ends 71 and 74 is changed by the sliding of the inner 64.

By such operations of the arm 61 and the arm 62, the distance between the mounting unit 11 and the body of the stand 10 (column) is changed. That is, the mounting unit 11 is arranged slidably relative to the body of the stand 10 in the horizontal direction in the drawing. In practice, on the opposite side face of the mounting unit 11, two arms similar to the arms 61 and 62 are connected. That is, the mounting unit 11 is practically supported to the body of the stand 10 with four arms. Since the opposite arms (not shown) are the same as the arms 61 and 62 shown in FIG. 8 in construction, the description is omitted. In order to increase the strength (rigidity), there are provided two shafts in the arm 61 extending to the opposite arms (not shown) in a longitudinal direction perpendicular to the plane of the figure.

The shaft 76 is provided with a connection component 65 rotatable about the shaft 76 in double arrow 85 direction. That is, one end of the connection component 65 is connected to the shaft 76 and the other end is rotatably connected to one end of an air cylinder 66 and a gas spring 67. The other ends of the air cylinder 66 and the gas spring 67 are connected to the body of the stand 10 (column), so that the pantograph mechanism 42 is operated so as to slide the mounting unit 11 forward.

The gas spring 67 has a piston structure using a predetermined gas, such as nitrogen, so as to move in longitudinal extending and contracting directions as shown in double arrow 86. The gas spring 67 exerts a force in an extending direction (direction in that the piston is pushed back against an external force) against the external force applied in a direction in that the piston is compressed. That is, when the mounting unit 11 is pushed rearward (the mounting unit 11 is slid toward the body of the stand 10), the arms 61 and 62 of the pantograph mechanism 42 are opened in the horizontal direction in the drawing, so that the connection component 65 is raised in the vertical direction in the drawing. Then, the distance between both ends of the gas spring 67 is reduced, so that the piston of the gas spring 67 is compressed. The gas spring 67 exerts a force pushing back (extending) the piston against such an external force, and consequently, it applies a force to the pantograph mechanism 42 for forward pushing the mounting unit 11.

Also, the air cylinder 66 exerts a reaction force during expansion/contraction in the longitudinal direction (piston direction) by adjusting the volume of air coming in and out of the cylinder. That is, the combination of the air cylinder 66 and the gas spring 67 yields a spring mechanism with a desired spring constant.

Owing to such a spring mechanism (the air cylinder 66 and the gas spring 67), the pantograph mechanism 42 generally exerts a force pushing the mounting unit 11 forward.

As shown in FIG. 8, when the mounting unit 11 is pushed forward, the monitor hook 31, the monitor lock 33, and the connector 32 protrude from the front surface of the mounting unit 11 as described above. Referring to FIG. 8, the mounting unit 11 is provided with the television receiver 21 and the monitor pipe 41 of the television receiver 21 is hung on the monitor hook 31.

Also, to the terminals of the connector 32, the external terminals of the television receiver 21 are electrically connected. The connector 32 is electrically connected to an electrical circuit 92 adjacent to the body (column) of the stand 10 via an electric cable 91. The rear of the connector 32 is slung up by a wire 93 from the vicinity of the connection end 73 via the restriction shaft 77. Then, when the mounting unit 11 is pushed forward as shown in FIG. 8, the rear of the connector 32 is pulled by the wire 93 so as to rotate the connector 32 and project it forward. When the mounting unit 11 is pushed back rearward, the distance between the connector 32 and the connection end 73 is reduced so as to loosen the wire 93 so that the connector 32 is rotated reversely due to a spring force which will be described later.

In the state of FIG. 8, the hook of the monitor lock 33 is not protruded so that the bottom of the monitor pipe 41 of the television receiver 21 is not locked.

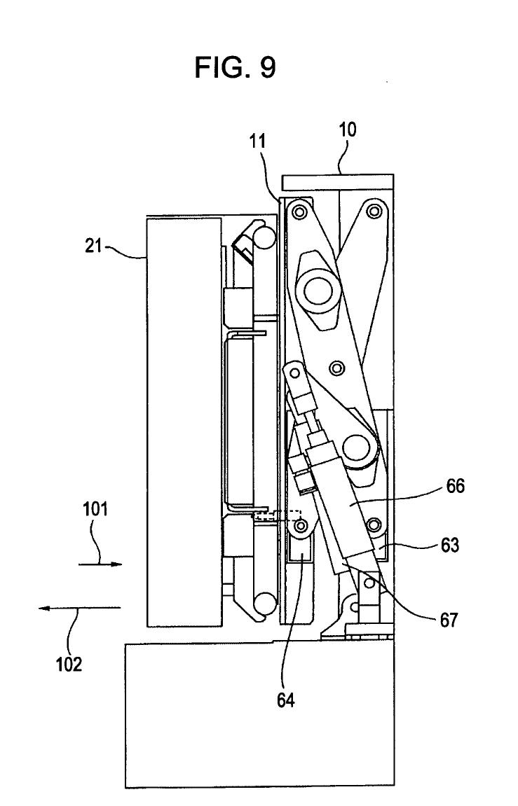

A locking mechanism (not shown) is prepared for fixing the mounting unit 11 to the body (column) of the stand 10. Thus, when a user rearward pushes the television receiver 21 from the state of FIG. 8 to a predetermined position as shown in arrow 81, although the mounting unit 11 is to be forward pushed again due to the force of the gas spring 67, by the operation of the locking mechanism (not shown), the mounting unit 11 only slides by a small distance as shown in arrow 82, and it is fixed in the rear as shown in FIG. 9.

FIG. 9 is a drawing of a state in that the mounting unit 11 having the television receiver 21 mounted thereon is slid rearward (the mounting unit 11 is locked to the body (column) of the stand 10 with the locking mechanism (not shown)).

As shown in FIG. 9, when the mounting unit 11 is rearward pushed, the inners 63 and 64 are slid downward so that the arms 61 and 62 are closed in the horizontal direction. Then, the pistons of the gas spring 67 and the air cylinder 66 are shrunken. Accordingly, although a forward pushing-back force is applied to the mounting unit 11, the mounting unit 11 is fixed in a rearward pushed-back state because of the fixing by the locking mechanism (not shown).

Since the television receiver 21 is mounted on the mounting unit 11 in this state, the monitor hook 31 is not closed so as to inclining protrude forward as it is. This reason (operation) will be described later.

Since the end portion of the connector 32 is inserted into the terminals of the television receiver 21 as it is, by pushing the mounting unit 11 rearward, although the wire 93 is loosened, the connector 32 is not closed by getting stuck on the casing of the television receiver 21. That is, in the state shown in FIG. 9, the television receiver 21 is electrically connected to the electric circuit 92 adjacent to the body of the stand 10, so that the television receiver 21 receives power via the connections, and the television receiver 21 functions as the scalable TV system 1 in cooperation with the other television receivers 21.

When the mounting unit 11 is rearward pushed as shown in FIG. 9, the hook is protruded from the monitor lock 33 so that by hanging the connection members 53A and 53B (FIG. 7) of the monitor pipe 41 of the television receiver 21, the bottom of the television receiver 21 is fixed (locked). That is, in the state of FIG. 9, the television receiver 21 mounted on the mounting unit 11 is fixed with the monitor hook 31 and the monitor lock 33 so as not to move in any direction. Thereby, the stand 10 can stably mount the television receiver 21 thereon.

When the mounting unit 11 is again pushed rearward from the state of FIG. 9 in arrow 101 direction, the locking mechanism (not shown) is cancelled so that the mounting unit 11 is forward slid as shown in arrow 102 (becomes the state shown in FIG. 8).

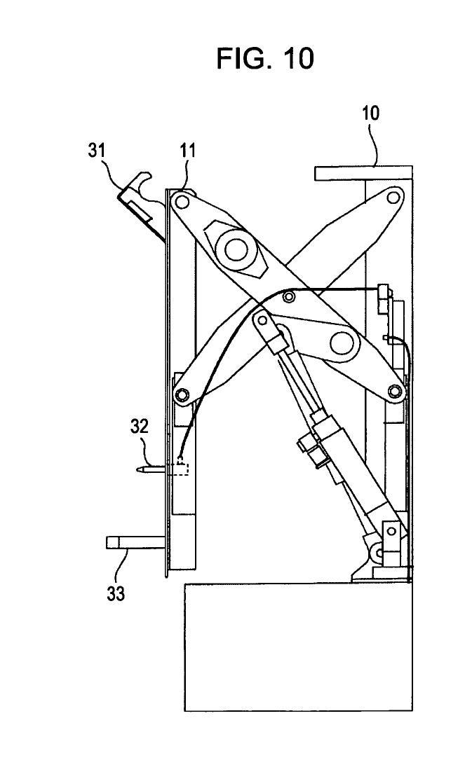

FIG. 10 is a drawing of a state in that the television receiver 21 is removed from the mounting unit 11 in the state of FIG. 8. As shown in FIG. 10, even if the television receiver 21 is removed from the mounting unit 11 in the state of FIG. 8, the monitor hook 31, the connector 32, and the monitor lock 33 are protruded from the front surface of the mounting unit 11 as they are.

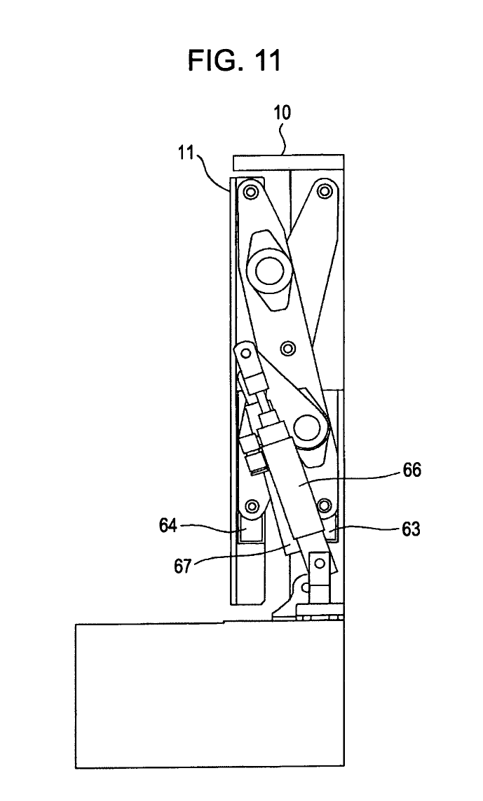

When the mounting unit 11 is again pushed rearward from the state of FIG. 10, the locking mechanism is operated in the same way as in FIG. 9, so that the mounting unit 11 is fixed rearward as shown in FIG. 11. However, the monitor hook 31, the connector 32, and the monitor lock 33 are accommodated within the mounting unit 11 in this case as described above, so that the front surface of the mounting unit 11 becomes one flat plane.

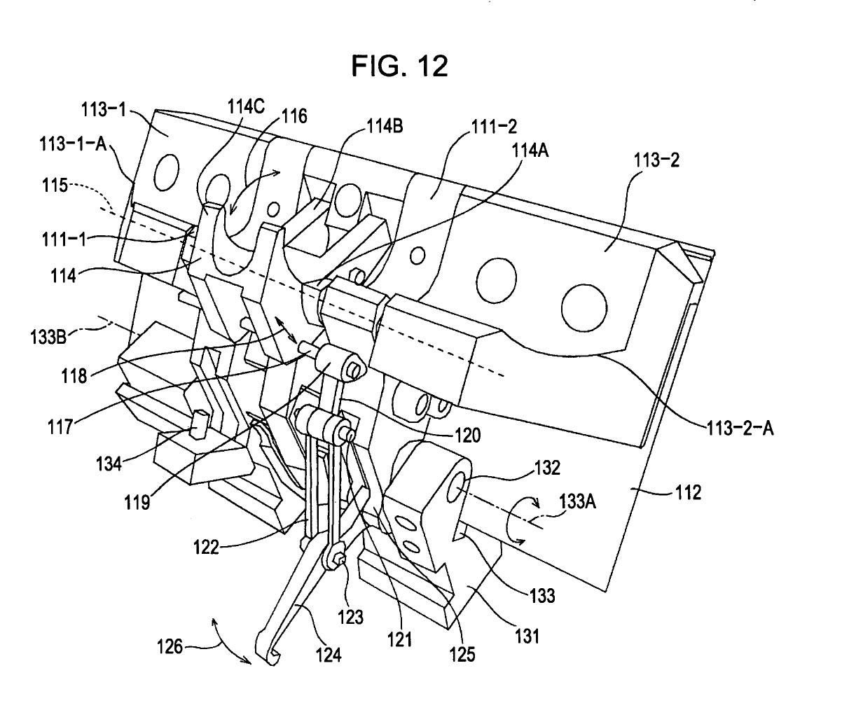

Next, every part will be described in detail. First, the monitor hook 31 will be described. FIG. 12 is a perspective view of the detailed structure of the monitor hook 31.

As shown in FIG. 12, the monitor hook 31 includes a hook 111-1 and a hook 111-2 which are movable to be open and shut from upside as mentioned above. The hook 111-1 and the hook 111-2 are connected together in the lower section while they are separated into two (the hook 111-1 and the hook 111-2) in the upper part. The hook 111-1 and the hook 111-2 will be referred to as the hook 111 below unless individually specified.

The hook 111 is provided with a front panel 112 which becomes part of the front surface of the mounting unit 11 when the hook 111 is closed. On the back surface (the back of the surface which becomes part of the front surface of the mounting unit 11 when the hook 111 is closed, the near side surface in the drawing) of the front panel 112, the hook 111 is constructed so that the monitor pipe 41 is to be set. The portion, where the monitor pipe 41 is to be in contact with, is curved in conformity with contours of the set monitor pipe 41 so as to stabilize the mounted television receiver 21.

On both sides of the hook ill on the back surface of the front panel 112, a hook auxiliary part 113-1 and a hook auxiliary part 113-2 are provided so as to sandwich the hook 111 therebetween. The hook auxiliary part 113-1 and the hook auxiliary part 113-2 are auxiliary members for supporting the monitor pipe 41 hung at the hook 111. A curved surface 113-1-A of the hook auxiliary part 113-1 and a curved surface 113-2-A of the hook auxiliary part 113-2 are to be in contact with the set monitor pipe 41, and are curved in conformity with contours of the set monitor pipe 41 so as to stabilize the mounted television receiver 21.

At a part between the hooks 111-1 and 111-2 for supporting the monitor pipe 41, the monitor pipe 41 is to be set. In order to further stabilize the set monitor pipe 41, there is provided a chuck 114 for fixing the monitor pipe 41 by pushing it from the upside as well as for detecting the television receiver 21 hung on the mounting unit 11.

A shaft 114A of the chuck 114 is journaled on the hook 111-1 rotatable about the axis of the hook 111-1 (dotted line 115) in double arrow 116 directions within a predetermined rotatable angular range. Another shaft (not shown, similar to the shaft 114A, and totally referred to as the shaft 114A) of the chuck 114 is journaled on the hook 111-2 rotatable about the axis of the hook 111-2 (dotted line 115) in double arrow 116 directions within a predetermined rotatable angular range. The chuck 114 is swingable about the shaft 114A like a cradle. Referring to FIG. 12, the chuck 114 has two functions different from each other using a part 114B on the back side of the shaft 114A and a part 114C on the front side of the shaft 114A, respectively.

For example, the part 114B is flatly raised toward the back of the shaft 114A, so that only the part 114B is floated at points of contact with the monitor pipe 41 because of the curvature difference from the curved surfaces 113-1-A and 113-2-A. Hence, when the monitor pipe 41 is hung (mounted) on the monitor hook 31 in this state of the chuck 114, the monitor pipe 41 pushes down the part 114B, so that the chuck 114 is rotated about the shaft 114A.

To the lower portion of the chuck 114, a guide part 119 is connected via a parallel pin 117. The guide part 119 is connected to the chuck 114 rotatably about the parallel pin 117. The guide part 119 has an oval side view, and is constructed so as to touch the hook 111-2 with a sharp portion (large curvature) of the guide part 119. When the chuck 114 is rotated as mentioned above, the guide part 119 connected thereto via the parallel pin 117 is also moved as shown in double arrow 118. At this time, the sharp portion (large curvature) of the guide part 119 moves along the curved surface of the hook 111-2, so that the guide part 119 rotates about the parallel pin 117 along with this movement.

The guide part 119 is fixedly connected to a link 120, which is in turn connected to a link 122 via a parallel pin 121. The link 122 is rotatable around the link 120 (the link 120 around the link 122) and about the parallel pin 121. Furthermore, the link 122 is connected to a link 124 via a parallel pin 123. One end of the link 124 is connected to the hook 111-2 rotatably about a rotation shaft 125. The link 122 is connected to a roughly central portion of the link 124 via the parallel pin 123.

The link 124 is a member for hooking or separating a pin provided in a shaft which will be described later. That is, as mentioned above, when the chuck 114 rotates, the movement is transmitted to the link 124 via the parallel pin 117, the guide part 119, the link 120, the parallel pin 121, the link 122, and the parallel pin 123. Thereby, the other end of the link 124 moves up and down about the rotation shaft 125 as shown in double arrow 126.

In other words, the part 114B of the chuck 114 detects the setting of the monitor pipe 41. Then, the parallel pin 117, the guide part 119, the link 120, the parallel pin 121, the link 122, and the parallel pin 123 inform the link 124 of the detected result. The link 124 controls the open/close of the hook 111 (the monitor hook 31) by hooking or separating the pin provided in the shaft which will be described later on the basis of the detected result informed.

In the part 114C on the front side of the shaft 114A of the chuck 114, when the monitor pipe 41 is set on the hook 111, the entire chuck 114 rotates so as to push the set monitor pipe 41 roughly from the upside as mentioned above. By doing so, the television receiver 21 mounted on the mounting unit 11 can be fixed further stably.

Furthermore, when the set monitor pipe 41 is removed by a user, the part 114C is pushed to open (to the front side in FIG. 12) by the monitor pipe 41 being removed. Thereby, the entire chuck 114 is rotated about the shaft 114A so as to raise the part 114B, which has been pushed down, for returning it to the position capable of detecting the mounting of the monitor pipe 41. That is, the part 114C detects the removal of the monitor pipe 41 as well as returns the detection portion (the part 114B) for detecting the mounting the monitor pipe 41 to the initial state (the position capable of detecting the mounting of the monitor pipe 41) by resetting the state of the chuck 114. By the movement of the chuck 114, the link 124, which has been raised, is pushed down.

The hook 111, which is a movable part of the monitor hook 31, is connected to a hook support column 131 rotatably about the axis (dotted lines 133A and 133B) of a parallel pin 132 within a predetermined rotatable angular range. The hook support column 131 is provided with a groove 133 to be entered by the bottom of the front panel 112 for opening the hook 111. When the hook 111 is opened, the bottom of the front panel 112 is brought into contact with the inner surface of the groove 133 and stopped. The hook support column 131 is also provided with a position definition part 134 for defining the position when the hook 111 is closed. When the hook 111 is closed, part of the hook 111 is brought into contact with the position definition part 134 so as to stop the closing motion.

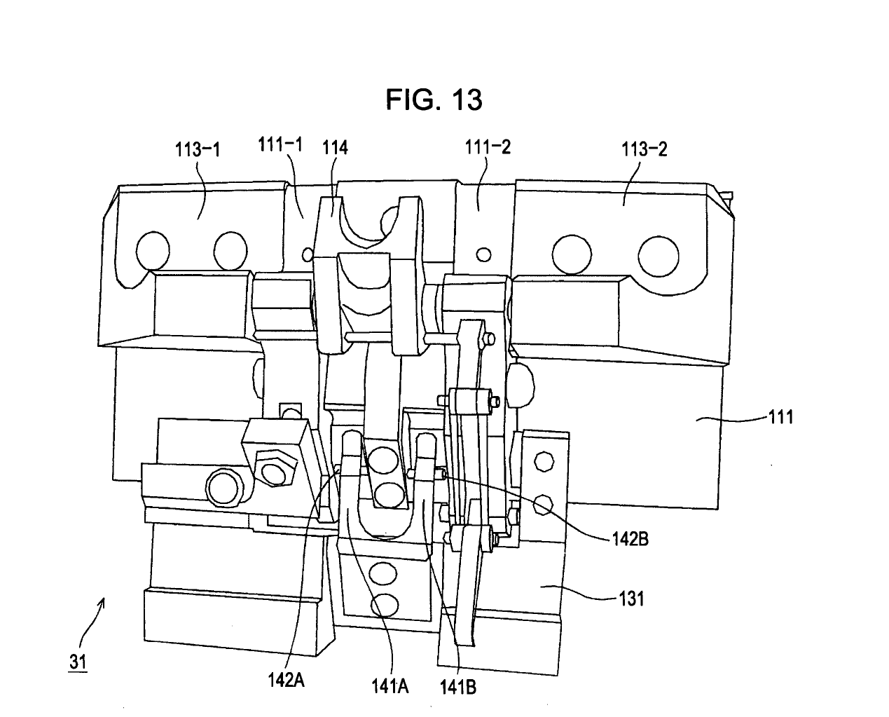

FIG. 13 is a perspective view of the monitor hook 31 viewed in a direction different from that of FIG. 12.

As shown in FIG. 13, in the lower portion of the hook 111, pins 142A and 142B are provided while leaf springs 141A and 141B are provided in the hook support column 131. The leaf springs 141A and 141B are arranged so as to be in contact with the pins 142A and 142B. Portions of the leaf springs 141A and 141B to be in contact with the pins 142A and 142B are convexly curved relative to the pins 142A and 142B. Due to the curved shape, the hook 111 is stabilized in opened and closed states to the utmost relative to the hook support column 131.

That is, as described above, the hook 111 is rotated about the axis of the parallel pin 132 relative to the hook support column 131 so as to open (the state capable of hanging the monitor pipe 41) and close (the state in that the front panel 112 is flush with the front surface of the mounting unit 11). Due to the structure of the leaf springs 141A and 141B and the pins 142A and 142B, the hook 111 is stabilized only in opened and closed states to the utmost. For example, in a halfway state (the hook 111 is opened to the hook support column 131 halfway), a force must be applied to the hook 111 so as to further open the hook 111 or to close the hook 111 due to structure of the leaf springs and the pins mentioned above.

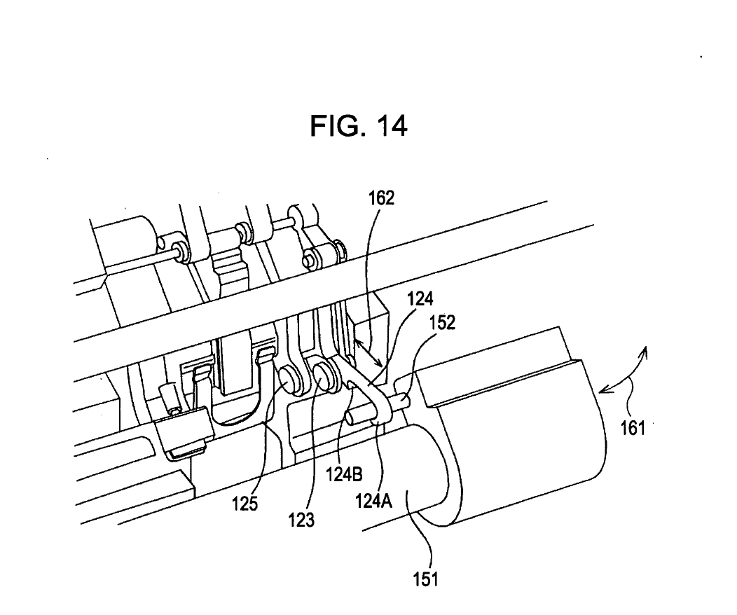

FIG. 14 is a drawing of the structure of the link 124 shown in FIG. 12. The link 124 is provided with a guide groove formed on the bottom surface for guiding a pin 152 of a horizontal shaft 151 provided in the arm 61 and the arm 62.

The shaft 151 is fixed to the arm 61 and the arm 62, and when the mounting unit 11 is slid back and forth, the shaft 151 changes in position relative to the monitor hook 31 in conformity with the rotations around each other of the arms 61 and 62 constituting the pantograph mechanism 42 using the connection end 75 as the rotation axis. As is apparent from the comparison between FIGS. 8 and 9 or FIGS. 10 and 11, the distance between the monitor hook 31 and the shaft 151 fixedly provided in the arm 61 or 62 is changed due to the position of the mounting unit 11 (by sliding the mounting unit 11 back and forth).

The pin 152 fixedly provided in the shaft 151 is also swung relative to the monitor hook 31 in accordance with the movement of the shaft 151 relative to the monitor hook 31. On the bottom surface of the link 124, a guide groove is formed for following the movement of the pin 152 moving in such a manner. At both ends of the guide groove, hook portions 124A and 124B are formed, respectively, so that the link 124 is pulled or pushed by the pin 152.

Although will be described in detail, when the hook portion 124A of the link 124 is pulled by the pin 152, for example, the movement of the link 124 is transferred to the hook 111 via the rotation shaft 125, the hook 111, which has been opened, is pulled inside so as to close.

Also, when the hook portion 124B of the link 124 is pushed by the pin 152, for example, the movement of the link 124 is transferred to the hook 111 via the rotation shaft 125, the hook 111, which has been closed, is pushed outside so as to open.

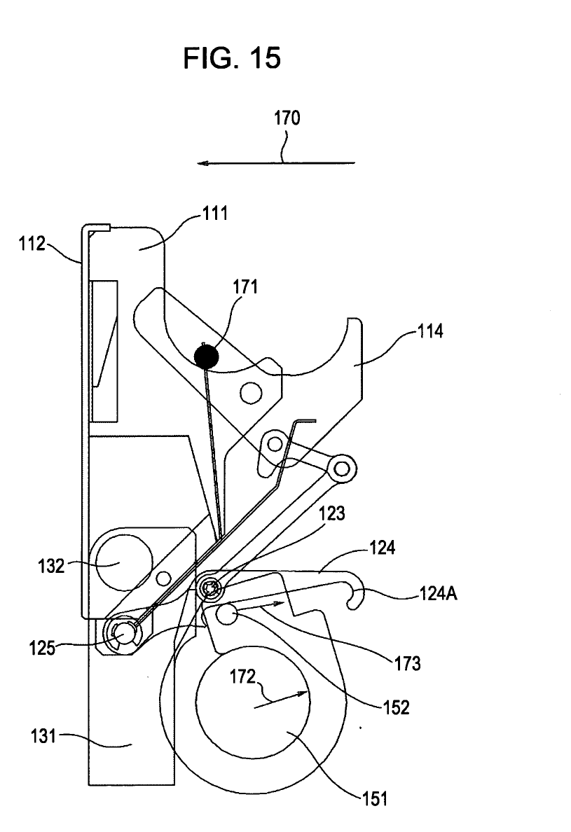

Next, the operation of the monitor hook 31 configured in such a manner will be described. First, a process from the closed state of the hook 111 until the hook 111 is opened will be described. For example, when the mounting unit 11 without the television receiver 21 mounted thereon is rearward pushed and fixed, the hook 111 is closed. FIG. 15 is a side perspective view of the situation of the monitor hook 31 at that time.

As shown in FIG. 15, when the mounting unit 11 is rearward pushed, the hook 111 is upright (closed) relative to the hook support column 131, and further, the above-mentioned shaft 151 (the pin 152) comes close to the hook support column 131 (being positioned closer to the hook support column 131 within the movable range of the shaft 151).

From this state, when a user unclasps the mounting unit 11 after once pressing the mounting unit 11 and canceling locking, the mounting unit 11 is pushed forward due to the force of the gas spring 67 as shown in arrow 170. In accordance with the sliding of the mounting unit 11, the shaft 151 moves in a drawing away direction from the hook support column 131 as shown in arrow 172. Specifically, the shaft 151 moves in a rotational direction about a black circle 171 shown in FIG. 15. Hence, the pin 152 also moves in the rotational direction about the black circle 171. That is, the pin 152, as shown in arrow 173, moves toward the hook portion 124A along a parallel guide portion 124C of the link 124. In other words, the hook portion 124A of the link 124 is raised by the movement of the pin 152. In addition, the black circle 171 is a virtual point for descriptive convenience and does not exist in practice.

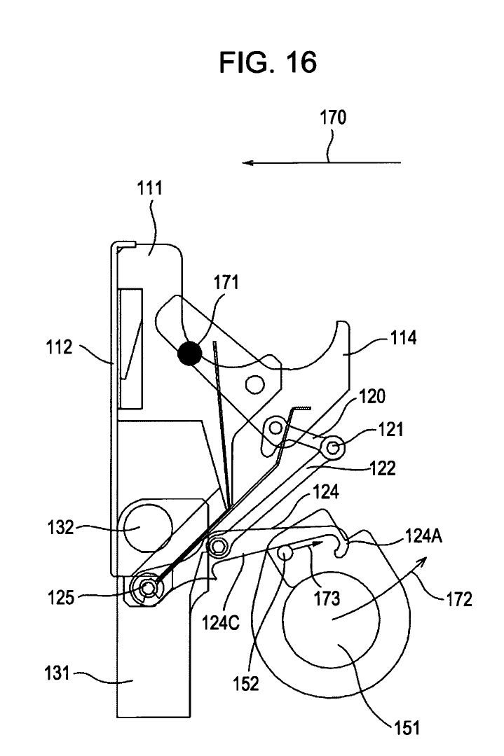

FIG. 16 is a side perspective view of the situation of the monitor hook 31 when the mounting unit 11 moves forward from the state of FIG. 15.

Referring to FIG. 16, the shaft 151 and the pin 152 are separated from the hook support column 131 in comparison with the case in FIG. 15. Thus, the pin 152 approaches the hook portion 124A closer than the case in FIG. 15. From the state of FIG. 16, the mounting unit 11 further slides forward (arrow 170) so that the shaft 151 and the pin 152 continue to rotate about the black circle 171 relative to the monitor hook 31 (arrows 172 and 173).

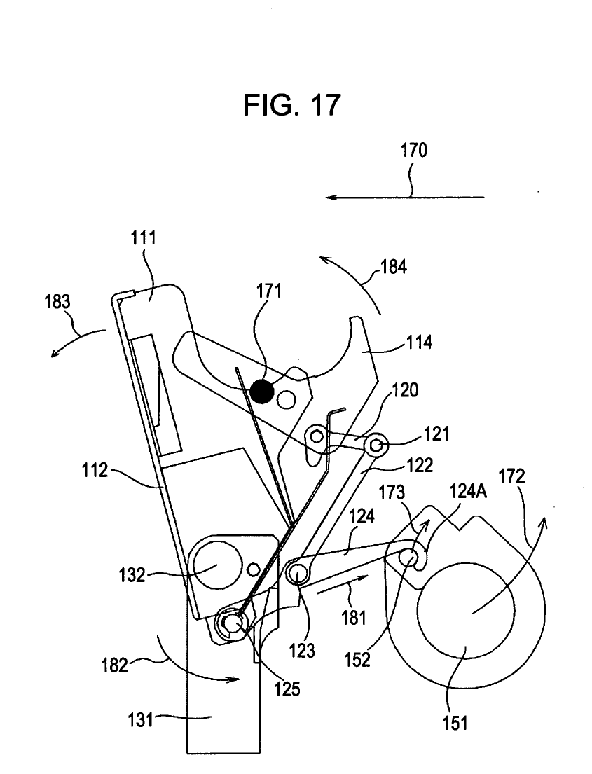

FIG. 17 is a side perspective view of the situation of the monitor hook 31 when the mounting unit 11 moves further forward from the state of FIG. 16.

Referring to FIG. 17, the shaft 151 and the pin 152 are further separated from the hook support column 131 in comparison with the case in FIG. 16. Thus, the pin 152 arrives at the hook portion 124A so as to further move in a direction arrow 173, and it starts to pull the hook portion 124A. By the pulling of the pin 152, the link 124 is drawn in a direction arrow 181, so that the rotation shaft 125 in the lower portion of the hook 111 is pulled and the lower portion of the hook 111 is rotated about the parallel pin 132 relative to the hook support column 131 as shown in arrow 182. That is, the upper portion of the hook 111, as shown in arrow 183, rotates about the parallel pin 132 so as to be forward inclined (the hook 111 starts opening). Along with this, the chuck 114 starts inclining forward as shown in arrow 184.

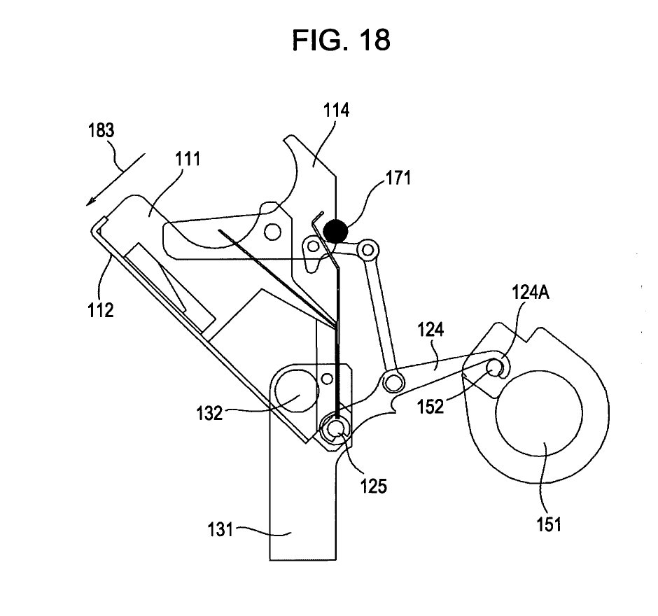

FIG. 18 is a side perspective view of the situation of the monitor hook 31 when the mounting unit 11 moves forward to be stabilized. When the mounting unit 11 is moved to the utmost front within the slidable range, the shaft 151 and the pin 152 stop moving toward the hook support column 131. That is, the hook portion 124A is pulled no more.

When the link 124 is pulled by the pin 152 in such a manner so that the hook 111 is opened to some extent, a force is applied to the hook 111 in a direction arrow 183 by the above-mentioned leaf springs 141A and 141B and the pins 142A and 142B, so that the hook 111 is fully opened and stopped.

Next, operations of components of the monitor hook 31 will be described when the mounting unit 11 without the television receiver 21 mounted thereon is pushed back rearward.

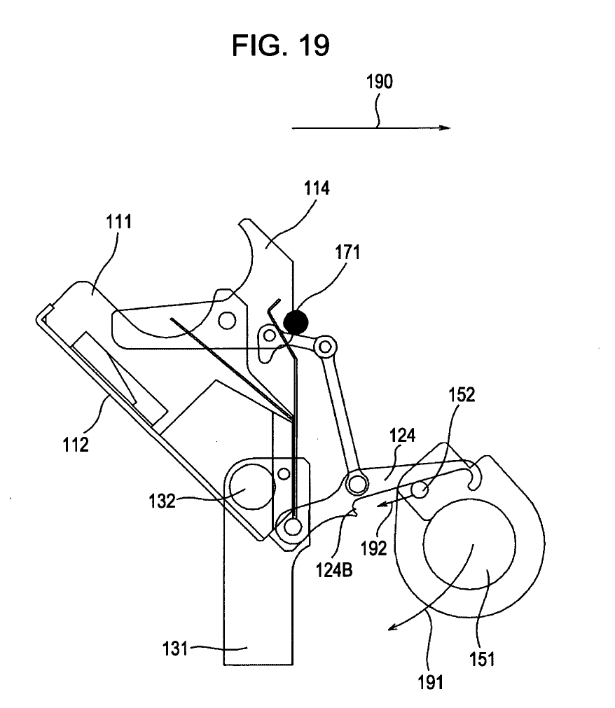

FIG. 19 is a side perspective view of the situation of the monitor hook 31 when the mounting unit 11 is rearward moved from the state of FIG. 18.

As shown in FIG. 19, when a user pushes the mounting unit 11 rearward in a direction arrow 190, the shaft 151 circulates about the black circle 171 so as to follow the trajectory of the movement shown in FIGS. 15 to 18 and to approach the hook support column 131. Along with this, the pin 152, as shown in arrow 192, also circulates about the black circle 171 so as to follow the trajectory of the movement shown in FIGS. 15 to 18 and to approach the hook support column 131.

At this time, the link 124 is not hung up, so that the hook portion 124A descends in accordance with the downward movement of the pin 152.

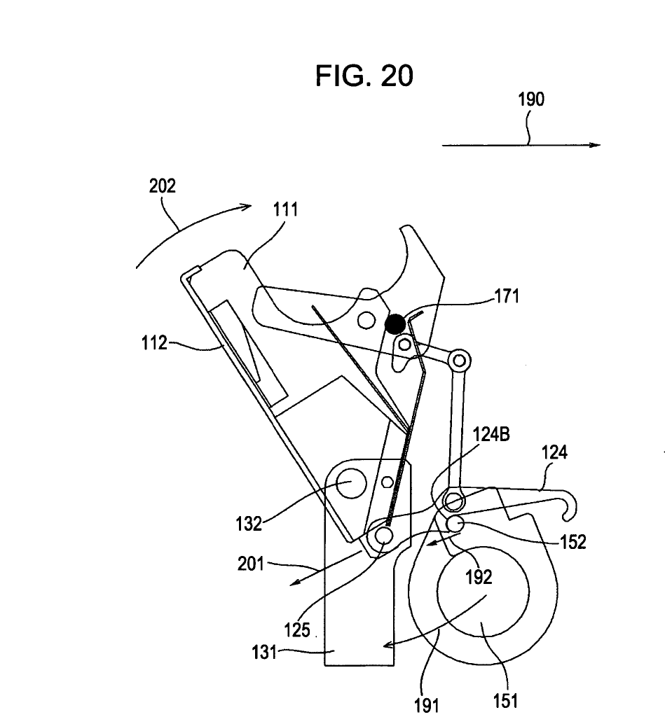

FIG. 20 is a side perspective view of the situation of the monitor hook 31 when the mounting unit 11 is rearward moved further from the state of FIG. 19.

As shown in FIG. 20, when the mounting unit 11 moves further rearward as shown in arrow 190, the pin 152, as shown in arrow 193, circulates about the black circle 171 and arrives at the hook portion 124B. When the shaft 151 further moves as shown in arrow 191, the pin 152 also moves as shown in arrow 192 so as to push the hook portion 124B. Thereby, the lower portion of the hook 111 is pushed via the link 124, and is protruded forward as shown in arrow 201. In other words, the hook 111 rotates about the parallel pin 132 and the upper portion of the hook 111 is rearward pushed as shown in arrow 202. That is, by the pushing the hook portion 124B with the pin 152, the hook 111 becomes closed (upright) relative to the hook support column 131.

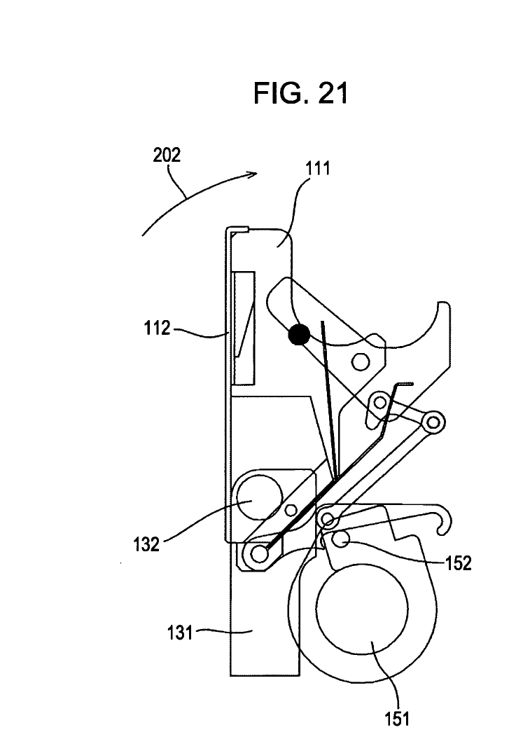

FIG. 21 is a side perspective view of the situation of the monitor hook 31 when the mounting unit 11 is rearward moved and fixed with a lock mechanism (not shown). When the hook 111 is moved to a locking position in the rear of the slidable range, the shaft 151 and the pin 152 stop moving relative to the hook support column 131. That is, the hook portion 124B is pushed no more.

When the link 124 is pushed by the pin 152 in such a manner so that the hook 111 is closed to some extent, a force is applied to the hook 111 in a direction arrow 183 by the above-mentioned leaf springs 141A and 141B and the pins 142A and 142B, so that the hook 111 is fully closed and stopped (upright).

When the mounting unit 11 is rearward pushed without the television receiver 21, as described with reference to FIG. 5, the monitor hook 31 becomes closed because the link 124 is pushed by the pin 152, so that the front surface of the mounting unit 11 becomes flat without unevenness due to the monitor hook 31.

The television receiver 21 is mounted/dismounted always in the state that the mounting unit 11 is slid forward. When the mounting unit 11 is pushed rearward, the television receiver 21 is not hung on the monitor hook 31, so that the monitor hook 31 is not required at this time. If the monitor hook 31 were left protruded with unnecessary unevenness, it might be not only visually unfavorable but also other objects might be damaged due to collision with convex portions. Also, users might be injured by hitting a hand or body against the convex portions. Hence, by accommodating the monitor hook 31 within the mounting unit 11 when it is unnecessary, the design, durability, and safety of the stand 10 can be improved.

In other words, if the television receiver 21 is to be hung on the monitor hook 31 in the state that the mounting unit 11 is forward slid, a user can make the monitor hook 31 project forward so as to be used as a hook only by pushing one end of the mounting unit 11 and canceling the locking. That is, a user can easily mount/dismount the television receiver 21 (monitor) on/off the stand 10.

This structure is incorporated in all the mounting units 11. Hence, a user can easily mount/dismount an arbitrary television receiver 21 (monitor) on/off the stand 10. In other words, the stand 10 can be provided with a plurality of the television receivers 21 (monitors) so that a user can easily mount on/dismount off an arbitrary television receiver 21 (monitor).

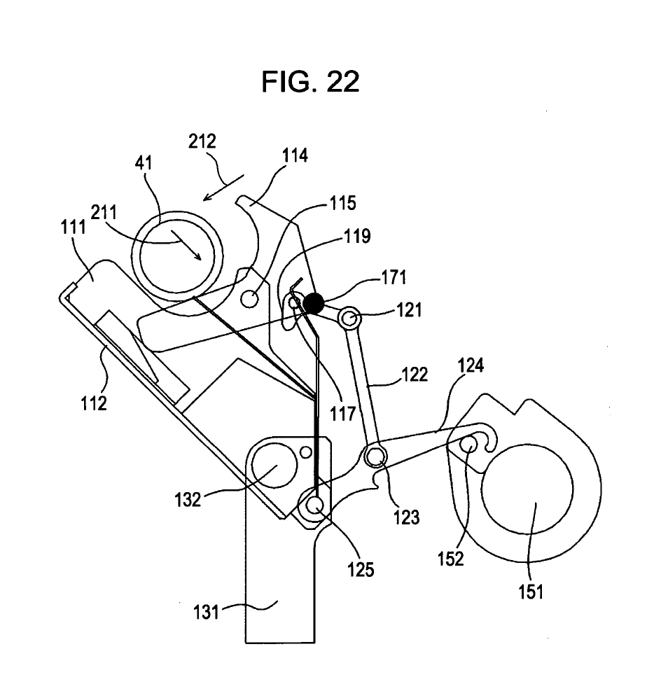

Then, the case where the monitor pipe 41 of the television receiver 21 is hung on such a monitor hook 31 will be described. The television receiver 21, as shown in FIG. 18, is mounted in the state that the mounting unit 11 is forward slid (forward stabilized state). FIG. 22 is a side perspective view of the situation of the monitor hook 31 for illustrating the situation in that the monitor pipe 41 is set on the monitor hook 31 of the mounting unit 11 slid forward in such a manner.

As shown in FIG. 22, when the monitor pipe 41 is set in the upper portion of the hook 111 as shown in arrow 211, the part 114B of the chuck 114 is pushed, so that the entire chuck 114 rotates about a shaft 115 so as to cover and fix the monitor pipe 41 with the part 114C set as shown in arrow 212 from roughly upside.

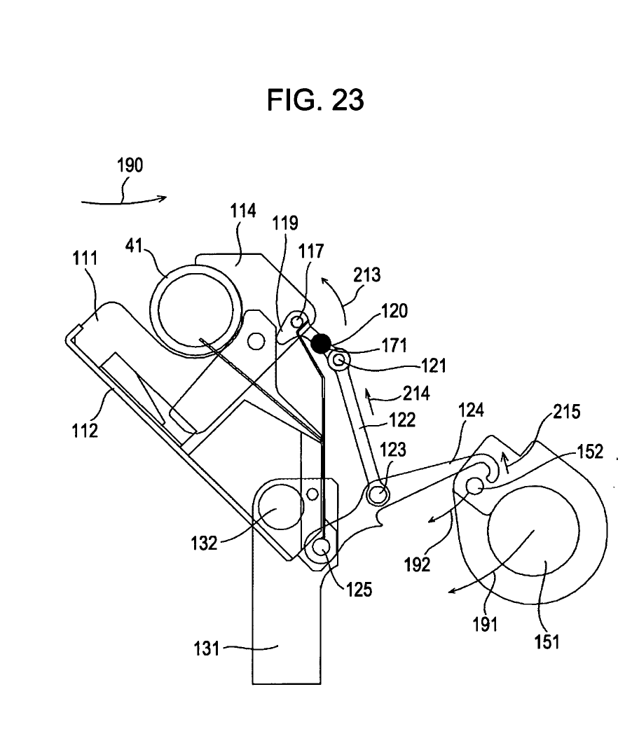

FIG. 23 is a side perspective view of the situation of the monitor hook 31 when the monitor pipe 41 is set at a position stable further from the state of FIG. 22.

Referring to FIG. 23, the monitor pipe 41 is securely set at the hook 111 so that the part 114B of the chuck 114 is further pushed and the part 114C pushes and fixes the detected monitor pipe 41 from roughly upside. That is, the chuck 114 detects the presence of the monitor pipe 41 with the set part 114B, and the part 114C fixes the detected monitor pipe 41 from roughly upside. Thereby, the monitor pipe 41 is more stably fixed. In other words, the mounting unit 11 can fix the television receiver 21 more stably by suppressing a stagger of the television receiver 21.

Then, the rotational operation of the chuck 114 mentioned above (the detected result of the monitor pipe 41) is transmitted to the link 124 via the parallel pin 117, the guide part 119, the link 120, the parallel pin 121, the link 122, and the parallel pin 123. That is, by the rotation of the chuck 114, the parallel pin 117 is raised, so that the link 124 is raised in a rotational direction about the rotation shaft 125. In other words, one end of the link 124 adjacent to the hook portion 124A is raised as shown in arrow 215, and the guide portion 124C which has been in contact with the pin 152 is separated from the pin 152. At this time, the hook portion 124B of the link 124 is also raised in position.

In this state, in the same way as in the case of FIG. 19, when the mounting unit 11 is rearward slid (arrow 190), the shaft 151 starts rotating about the black circle 171 so as to approach the hook support column 131 as shown in arrow 191. At this time, the pin 152 also starts rotating about the black circle 171 (arrow 192).

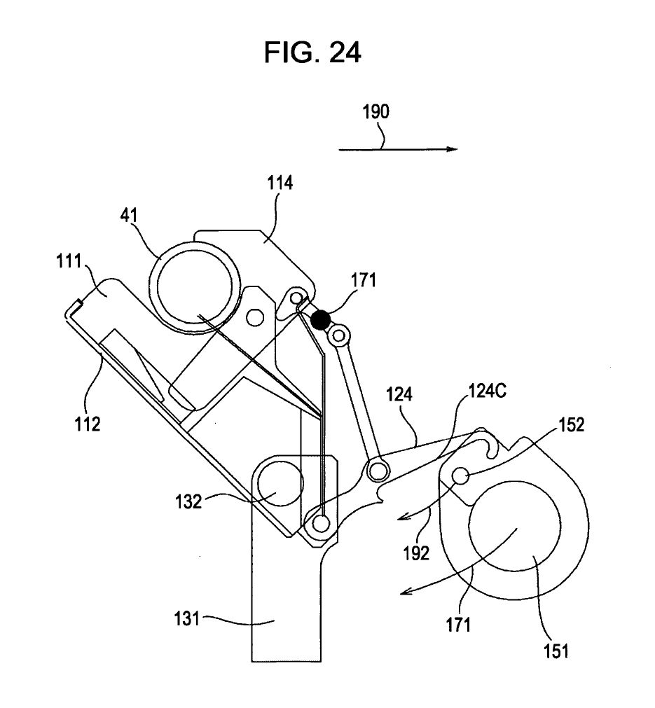

FIG. 24 is a side perspective view of the situation of the monitor hook 31 when the mounting unit 11 is rearward slid further from the state of FIG. 23.

Also, in the state of FIG. 24, in the same way as in the case of FIG. 19, when the mounting unit 11 is rearward slid (arrow 190), the shaft 151 and the pin 152 move as shown in arrows 191 and 192, respectively. However, in the case of FIG. 24, since the link 124 is lifted due to the structures of the parallel pins 117 to 123, even when the pin 152 moves downward as shown in arrow 192, the link 124 does not descend with this movement and is left separated from the pin 152.

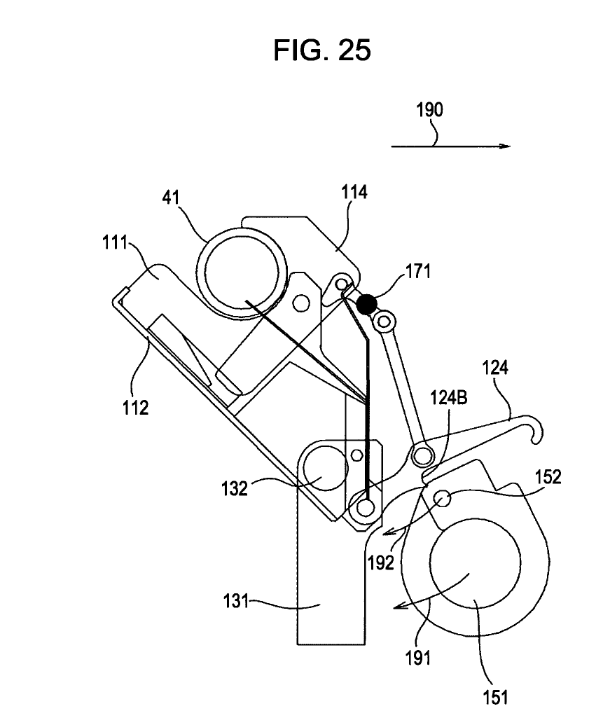

FIG. 25 is a side perspective view of the situation of the monitor hook 31 when the mounting unit 11 is rearward slid further from the state of FIG. 24.

As shown in FIG. 25, when the mounting unit 11 is further slid (arrow 190), the shaft 151 and the pin 152 further move as shown in arrows 191 and 192, respectively. Also, in this state, the link 124 is floated over (separated from) the pin 152. That is, the pin 152 approaches the hook support column 131 passing through below the hook portion 124B without catching on the hook portion 124B. Therefore, the link 124 and the lower portion of the hook 111 are not pushed, so that the hook 111 is not rotated about the parallel pin 132 and kept opened (not closed).

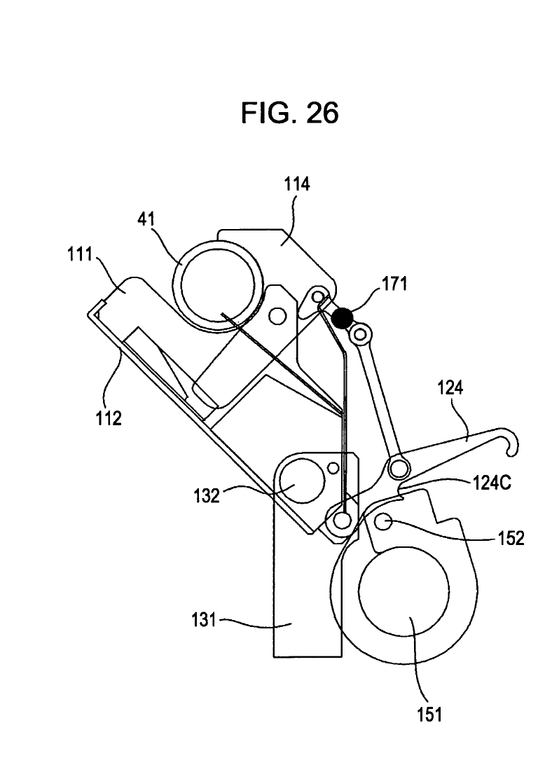

FIG. 26 is a side perspective view of the situation of the monitor hook 31 when the mounting unit 11 is rearward slid further from the state of FIG. 25, and it is locked to the body of the stand 10 with the locking mechanism (not shown).

As shown in FIG. 26, the pin 152 does not push the hook portion 124B of the link 124, and although the hook 111 having the monitor pipe 41 set thereon is fixed rearward, it is kept opened. Namely, when the monitor pipe 41 is set at the monitor hook 31 (the television receiver 21 is set at the mounting unit 11), the hook 111 is not to be closed, so that problems are suppressed in which an unnecessary load may be applied to the monitor pipe 41 and the monitor pipe 41 may be damaged. That is, in accordance with the sliding operation of the mounting unit 11 in the horizontal direction, the monitor hook 31 opens only if necessary for opening and closes only if necessary for closing.

The opening/closing the monitor hook 31 in accordance with the operation of the mounting unit 11 may be achieved by pulling/pushing it using a wire, a rubber, or a spring, for example. However, it is difficult to suppress the problems, in which an unnecessary load may be applied to the monitor pipe 41 and the monitor pipe 41 may be damaged, by opening the monitor hook 31 only if necessary for opening and by closing it only if necessary for closing, as mentioned above. If it were achieved, it might be difficult to have the improvement in durability because of using the spring and wire. However, in practice, to the monitor hook 31, a large load is applied i.e., the monitor pipe 41 (the television receiver 21) is hung, so that the improvement in durability is an important factor.

Although when the durability were to be improved using the wire and the spring, the structure might be complicated as well as the scale of the stand 10 might be too large due to the complexity. In this case, the manufacturing cost of the stand 10 might be increased as well as a plurality of the television receivers 21 could not be arranged in close vicinity to each other.

Whereas, the monitor hook 31 described above detects the monitor pipe 41 with a simple structure and it controls the hook 111 to be opened/closed on the basis of the detected result so as to achieve a hooking mechanism capable of reducing the manufacturing cost and the device scale as well as of improving the durability.

Using such a monitor hook 31 to be arranged by saving a space, the stand 10 can achieve the mounting unit 11 described above so as to mount a plurality of the television receivers 21 (monitors) thereon so that a user can easily mount/dismount an arbitrary television receiver 21 (monitor).

Then, the connector 32 shown in FIG. 4 will be described.

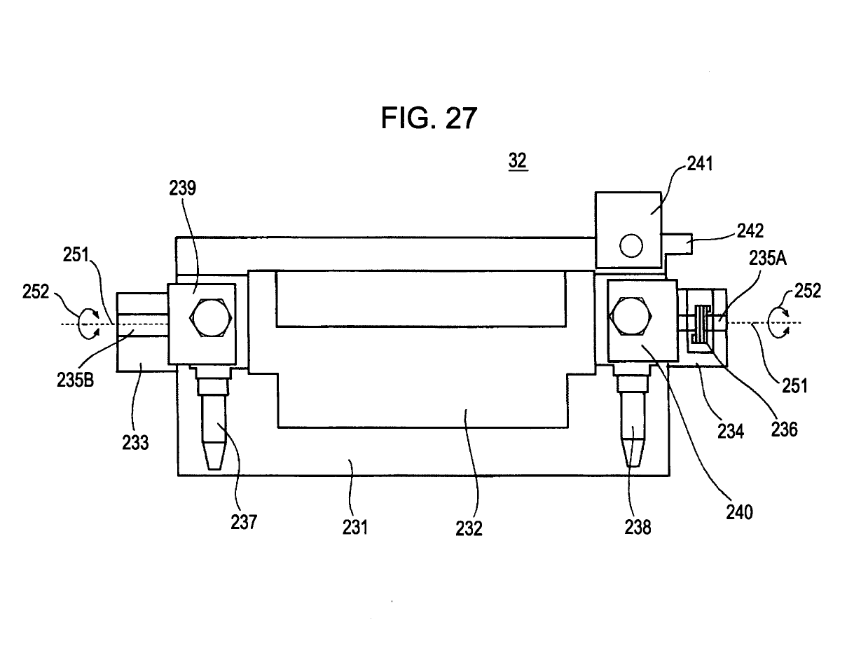

FIG. 27 is an explanatory view of the structure of the connector 32 viewed from the upside of the stand 10 when the connector 32 is opened.

Referring to FIG. 27, the connector 32 is provided with a front panel 231 arranged in the lower portion to constitute part of the front panel of the mounting unit 11 when the connector 32 is closed into the mounting unit 11. On the front panel 231, a plate-like terminal unit 232 is overlapped. Both ends of the front panel 231 overlapped on the terminal unit 232 in the horizontal direction are supported to the mounting unit 11 via columns 233 and 234, respectively. The front panel 231 overlapped on the terminal unit 232 is also connected to shafts 235A and 235B rotatably about a dotted line 251 as shown in double arrow 252. Namely, the front panel 231 overlapped on the terminal unit 232 is rotated about the shafts 235A and 235B so as to open from/close to the mounting unit 11.

The shaft 235A within the column 234 is provided with a coil spring 236 which applies a load in a rotational direction about the dotted line 251 (double arrow 252). By the coil spring 236, a force is applied to the front panel 231 and the terminal unit 232 in a closing direction.

At both ends of the terminal unit 232 in the horizontal direction, guide portions 237 and 238 are provided via connection portions 239 and 240, respectively. The connection portions 239 and 240 connect the guide portions 237 and 238 to the terminal unit 232 with a predetermined degree of freedom relative to the terminal unit 232. That is, the guide portions 237 and 238 have a movable range in vertical and horizontal directions by a predetermined angle relative to the terminal unit 232. This is for guiding the terminals of the television receiver 21 to the terminal unit 232 easily and securely when the terminals approach the terminal unit 232 in an oblique direction.

For example if the television receiver 21 is connected to the mounting unit 11 so as to be slightly displaced therefrom, the terminal unit 232 may not be securely connected to the terminals of the television receiver 21 due to the displacement. Whereas, when the guide portions 237 and 238 have the predetermined degree of freedom mentioned above so as to be able to bend along the terminal unit 232, even if the television receiver 21 is displaced, as long as within a some extent range, the guide portions 237 and 238 easily detect corresponding portions of the television receiver 21 so as to guide the television receiver 21 to an optimum position. Thereby, a user can connect the terminal unit 232 to the terminals of the television receiver 21 much more easily and securely.

In the rear of the terminal unit 232, a connection unit 241 is provided to which the electric cable 91 mentioned with reference to FIG. 8 is connected. In the rear of the front panel 231, a fixed part 242 is provided to which one end of the wire 93 mentioned with reference to FIG. 8 is connected. The front panel 231 is rotated by pulling the wire 93 connected to the fixed part 242 so as to open from the mounting unit 11. Since a force is applied by the coil spring 236 in a closing direction at this time, when the mounting unit 11 is rearward slid so that the wire 93 is slackened, the front panel 231 and the terminal unit 232 are closed in the mounting unit 11. However, when the television receiver 21 is mounted on the mounting unit 11, the terminal unit 232 and the guide portions 237 and 238 are inserted into the television receiver 21, so that they get stuck with the television receiver 21, and are not closed.

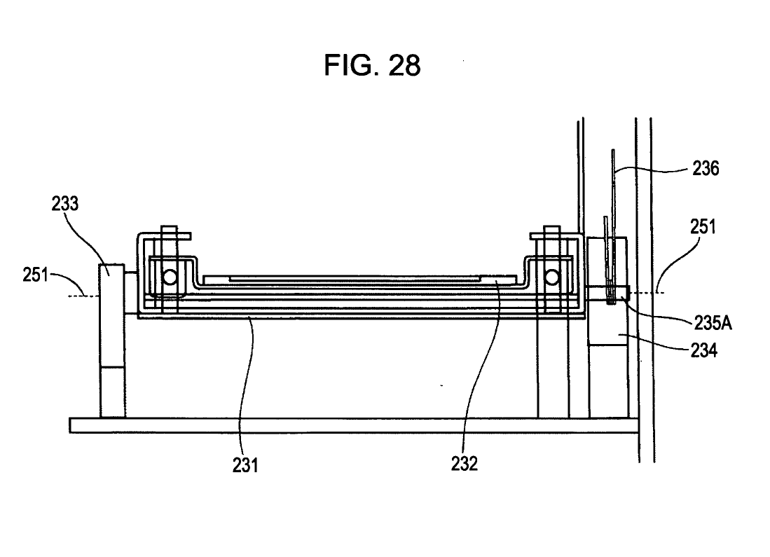

FIG. 28 is a perspective view of the connector 32 shown in FIG. 27 viewed from the back side of the stand 10. Components unnecessary for description are omitted. As shown in FIG. 28, the front panel 231 and the terminal unit 232 are supported on the columns 233 and 234 in a floated state from the mounting unit 11. Below the front panel 231 and the terminal unit 232, a predetermined space is secured so that the front panel 231 and the terminal unit 232 are not touched with the mounting unit 11 when they rotate. As mentioned above, the front panel 231 and the terminal unit 232 are rotatable about the dotted line 251.

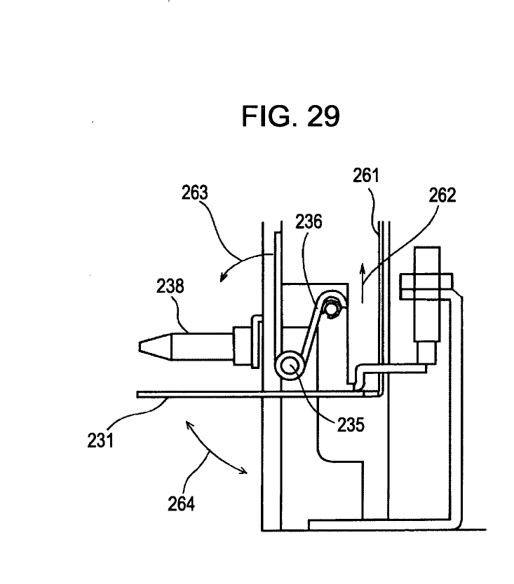

FIG. 29 is a perspective view of the connector 32 shown in FIG. 27 viewed from the side of the stand 10. Components unnecessary for description are omitted. As shown in FIG. 29, when a wire 261 connected to the fixed part 242 of the front panel 231 is pulled as shown in arrow 262, the front panel 231, etc., rotates about the shaft 235A so as to be opened. Both ends of the coil spring 236 are thereby closed in the rotational direction, so that, as shown in arrow 263, the coil spring 236 applies a force to the front panel 231, etc., so as to open the both ends in the rotational direction. In such a manner, the front panel 231, etc., rotates about the shaft 235A in accordance with the sliding of the mounting unit 11 in the back and forth directions.

Since the connector 32 does not support the television receiver 21, large durability is not needed. Hence, the connector 32 is constructed so as to rotate by such a coil spring. Namely, the connector 32 achieves the open/close operation according to the sliding of the mounting unit 11 in the back and forth directions with a structure simpler than that of the monitor hook 31, so that the design, durability, and safety of the stand 10 can be improved for the same reason as that of the monitor hook 31.

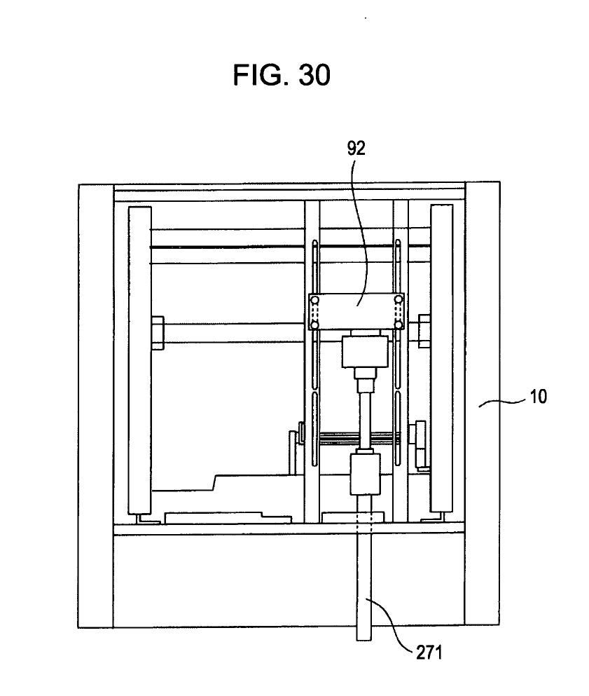

The above-mentioned terminal unit of the connector 32 is electrically connected to the electric circuit 92 through the electric cable 91. As shown in FIG. 30, the electric circuit 92 is electrically connected to electric systems (such as a power supply circuit and a communication circuit) accommodated in the racks 12 and the boxes 13 below the stand 10 through an electric cable 271, and further is electrically connected to the other mounting unit 11 via the electric configuration.

Then, the monitor lock 33 shown in FIG. 4 will be described.

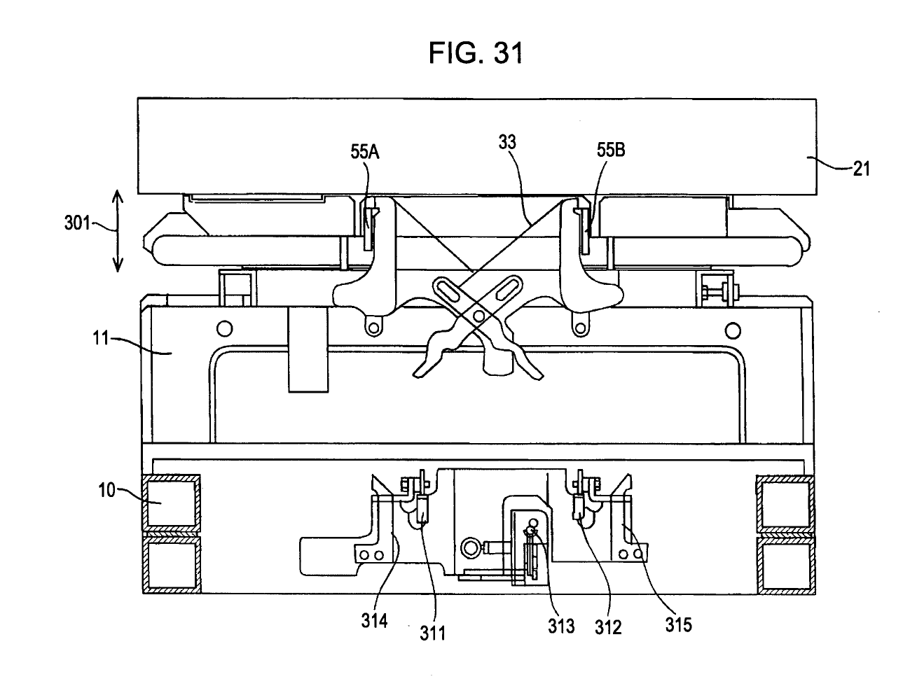

FIG. 31 is a perspective view of the stand 10 viewed from the upside for illustrating the monitor lock 33. Components unnecessary for description about the monitor lock 33 are omitted. The monitor lock 33 provided in the mounting unit 11 movable in the back and forth directions is a member for fixing the bottom side of the television receiver 21 hung on the monitor pipe 41 in the horizontal and back and forth directions.

More specifically, the monitor lock 33 has two hooks which will be described later, and the hooks are opened from the inner side to the outside so as to protrude and be hooked in the horizontal direction on connection members 55A and 55B connecting between the monitor pipe 41 below the television receiver 21 and the back face of the television receiver 21.

Also, in the body (column) of the stand 10 in the rear of the mounting unit 11, members are provided for aiding the operation of the monitor lock 33, such as hooks 311 and 312, a spring support 313, guide blocks 314 and 315.

The hooks 311 and 312, when the monitor lock 33 moves forward, make the monitor lock 33 open (protrude) like scissors by hanging a flange (below mentioned) provided in the monitor lock 33. The spring support 313, when the monitor lock 33 moves rearward, returns (closes) the monitor lock 33 opened like scissors to the original state by pushing the flange while buffering the hitting contact with a spring. The guide blocks 314 and 315, when the monitor lock 33 moves rearward, opens a hook (below mentioned) provided in the monitor lock 33 by controlling a trajectory of a cam follower (below mentioned) provided in the monitor lock 33.

FIG. 32 is a perspective view of the monitor lock 33 viewed from the lower rear for illustrating the structure of the monitor lock 33. Referring to FIG. 32, in the monitor lock 33, a left base plate 321, a right base plate 322, a flange 323, a flange 324, and a center base plate 325 are connected with a parallel pin 331 rotatably about the parallel pin 331 relative with each other. In addition, FIG. 32 is a drawing of the monitor lock 33 viewed from the below, and in practice, the monitor lock 33 is set upside down. Hence, the horizontal direction shown in FIG. 32 is opposite to the practical direction. However, the left base plate 321 denotes a left side base plate viewed from the front face of the mounting unit 11, and the right base plate 322 denotes a right side base plate viewed from the front face of the mounting unit 11.

The left base plate 321 is provided with a front-face panel 341 constituting part of the front surface of the mounting unit 11 in a state that the mounting unit 11 is rearward slid and the monitor lock 33 is accommodated within the mounting unit 11. Also, to the left base plate 321, a hook 342 is connected rotatably about a parallel pin 343 for hanging a connection member below the set television receiver 21 by protruding toward the outside when the mounting unit 11 is rearward slid and the monitor lock 33 gets back.

In the rear portion of the hook 342, a cam follower 344 with the rotatable peripheral portion is provided. A connection part between the cam follower 344 and the hook 342 (adjacent to the hook the hook 342) is connected to the vicinity of the parallel pin 343 of the left base plate 321 (adjacent to the left base plate 321) with a spring 345.

As described above, the hook the hook 342 rotates about the parallel pin 343 (a dotted line 351) in rotational directions as shown in double arrow 352. Thereby, as shown in arrows 354 and 354, a front hook-shaped portion of the hook 342 is protruded outside or retracted inside. The hook 342, when it is pushed inside as shown in arrow 355 by the hitting of the cam follower 344 on the guide block 315, rotates about the dotted line 351 so that the front hook-shaped portion protrudes outside as shown in arrow 353. The spring 345 is stretched at this time. When the guide block 315 and the cam follower 344 are separated, an external force exerting in an arrow 355 direction is eliminated, so that by the pulling back force of the spring 345, the hook 342 is rotated about dotted line 351 and the front hook-shaped portion is retracted inside as shown in arrow 354.

The side of the cam follower 344 is rotated about dotted line 356, which is the axis of the cam follower 344, in rotational directions as shown in double arrow 357. Thereby, the cam follower 344 can smoothly follow the internal side of the guide block 315. By the rotation of the side of the cam follower 344, the resistance force (frictional force) generated by the guide block 315 can be suppressed.

The left base plate 321 is provided with a pin 346 arranged adjacent to the front center for rotationally connecting one end of the flange 324. The pin 346 is arranged to be inserted into an oval guide hole 382 arranged at one end of the flange 324. The flange 324 is rotatable about the parallel pin 331. By the rotation of the flange 324, the position of the pin 346 relative to the center base plate 325 is moved. By the movement of the pin 346, the left base plate 321 is opened or closed.

Although the right base plate 322 is different in shape, it has the fundamental same structure as that of the left base plate 321. For example, a front-face panel 361 corresponding to the front-face panel 341 is provided; a hook 362 with a hook-shaped front portion (corresponding to hook 342) is rotatably connected to the right base plate 322 with a parallel pin 363 (corresponding to the parallel pin 343); in the rear of the hook 362, a cam follower 364 (corresponding to the cam follower 344) is provided; and a connection part between the cam follower 364 and the hook 362 (adjacent to the hook the hook 362) is connected to the vicinity of the parallel pin 363 of the right base plate 322 (adjacent to the right base plate 322) with a spring 365.

In the same way as in the left base plate 321 mentioned above, the hook the hook 362 rotates about the parallel pin 363 (dotted line 371) in rotational directions as shown in double arrow 372. Thereby, as shown in arrows 373 and 374, a front hook-shaped portion of the hook 362 is protruded outside or retracted inside. The hook 362, when it is pushed inside as shown in arrow 375 by the hitting of the cam follower 364 on the guide block 314, rotates about the dotted line 371 so that the front hook-shaped portion protrudes outside as shown in arrow 373. The spring 365 is stretched at this time. When the guide block 314 and the cam follower 364 are separated, an external force exerting in an arrow 375 direction is eliminated, so that by the pulling back force of the spring 365, the hook 362 is rotated about dotted line 371 and the front hook-shaped portion is retracted inside as shown in arrow 374.

The side of the cam follower 364, in the same way as in the cam follower 344, is rotated about dotted line 376, which is the axis of the cam follower 364, in rotational directions as shown in double arrow 357. Thereby, the cam follower 344 can smoothly follow the internal side of the guide block 315. By the rotation of the side of the cam follower 344, the resistance force (frictional force) generated by the guide block 315 can be suppressed.

The right base plate 322 is provided with a pin 366 arranged adjacent to the front center for rotationally connecting one end of the flange 323. The pin 366 is arranged to be inserted into an oval guide hole 381 arranged at one end of the flange 323. The flange 323 is rotatable about the parallel pin 331. By the rotation of the flange 323, the position of the pin 366 relative to the center base plate 325 is moved. By the movement of the pin 366, the right base plate 322 is opened or closed.

The movable range of the left base plate 321 and the right base plate 322 relative to the center base plate 325 is limited by the hitting of a parallel pin 332 on the convex portions of the left base plate 321 and the right base plate 322.

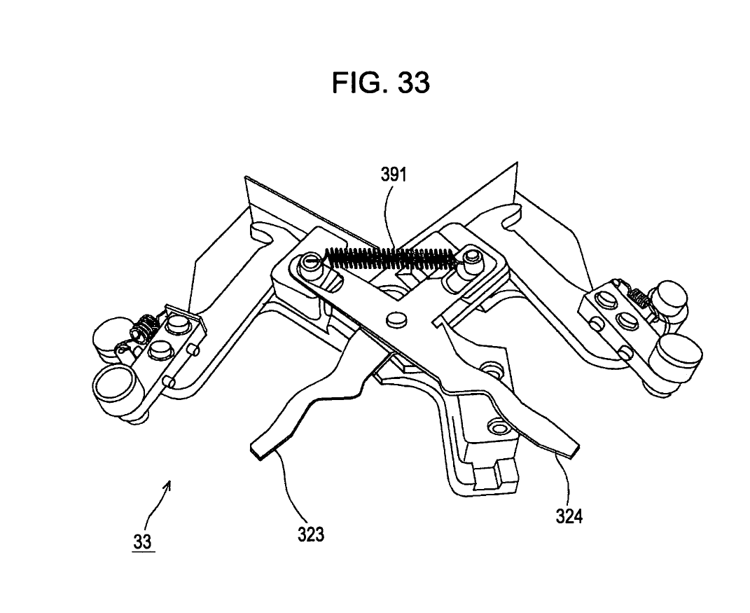

The pin 346 and the pin 366 are connected together via a spring 391. The spring 391 always applies a pulling force in a direction in that both ends are drawn to each other (a force to be compressed) to the pin 346 and the pin 366. The pin 346 and the pin 366, as described above, are inserted into the oval guide hole 381 and the guide hole 382, respectively. Namely, in the open/close operations of the flange 323 and the flange 324, by the force of the spring 391 in a direction in that the pin 346 and the pin 366 are drawn to each other, the flange 323 and the flange 324 are stabilized in two states. That is, as shown in FIG. 32, they are stabilized in a state in that they are opened to the utmost or in a state in that they are closed to the utmost (FIG. 33). In other words, since the pin 346 and the pin 366 are drawn to each other by the spring 391, they are stabilized at ends of the guide holes 381 and 382 adjacent to the parallel pin 331 or at opposite ends thereto. When the pin 346 and the pin 366 are positioned at ends of the guide holes 381 and 382 adjacent to the parallel pin 331, as shown in FIG. 32, the flange 323 and the flange 324 are opened to the utmost. Conversely, when the pin 346 and the pin 366 are positioned at opposite ends of the guide holes 381 and 382 adjacent to the parallel pin 331, as shown in FIG. 33, the flange 323 and the flange 324 are closed to the utmost.

The state of the monitor lock 33 shown in FIG. 32 is so-called “closed state” when it is accommodated into the mounting unit 11.

FIG. 33 shows the monitor lock 33 in a different state from that shown in FIG. 32. FIG. 33 shows a state in that the mounting unit 11 is forward slid and the monitor lock 33 protrudes from the front surface of the mounting unit 11. That is, the state of the monitor lock 33 shown in FIG. 33 is so-called “open state”.

In FIG. 33, the flange 323 and the flange 324 are in an utmost closed state, and are stabilized in this state with the spring 391.

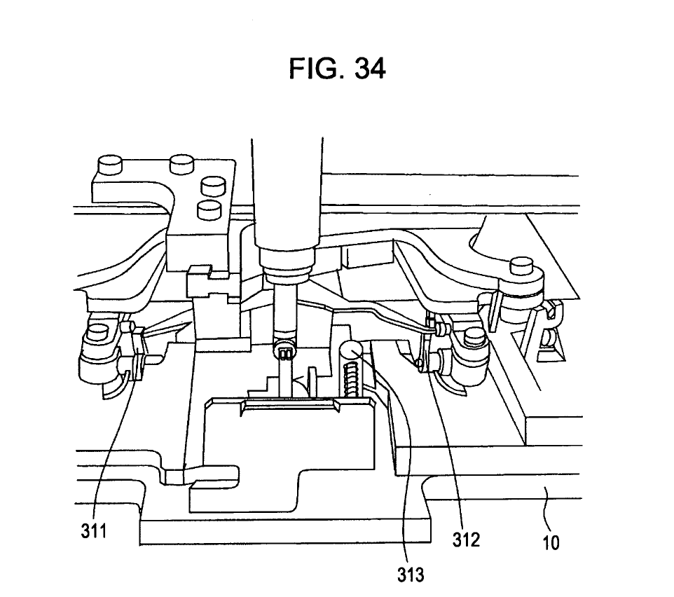

FIG. 34 is an explanatory view of the structure of the body of the stand 10. As described above with reference to FIG. 31, the hooks 311 and 312 are spaced at a predetermined interval in the horizontal direction in FIG. 34.

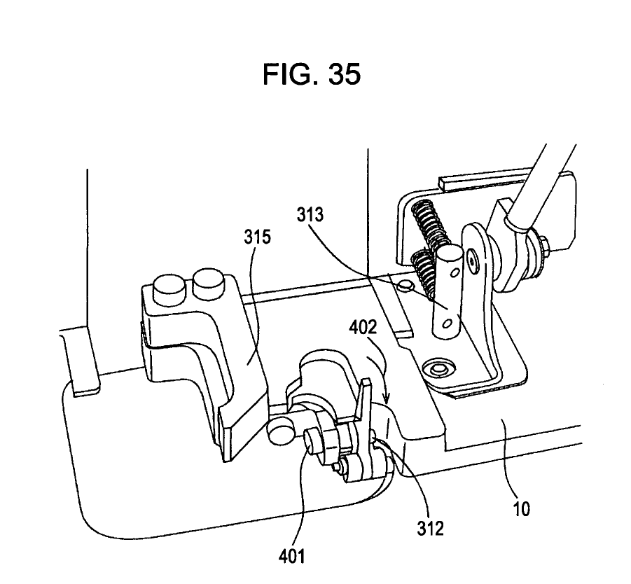

FIG. 35 is a drawing of these portions viewed from the front side of the stand 10. As shown in FIG. 35, the hook 312 is connected to the stand 10 using a pin 401, and is forward rotatable about the pin 401 and relative to the stand 10 as shown in arrow 402. However, the hook 312 is not to be rearward rotated further from the upright position of the hook 312 shown in FIG. 35. This is the same as in the hooks 311.

In the spring support 313, a contact portion with which the flange 323 of the monitor lock 33 is in contact is connected to the stand 10 via a spring. Thus, the spring support 313 pushes back the flange 323 so as to close the monitor lock 33 while suppressing the impact generated by the hitting of the monitor lock 33.

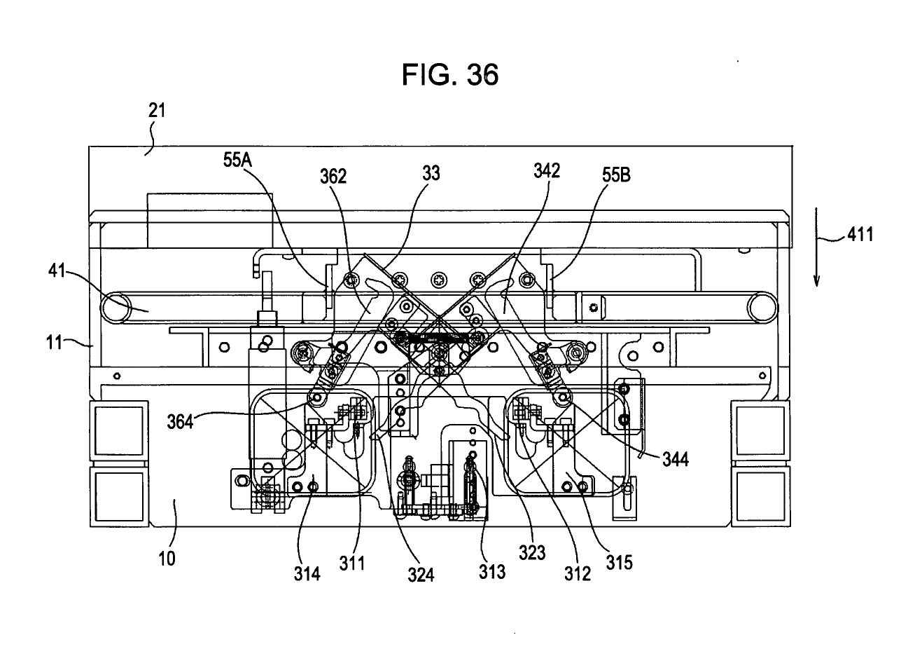

FIGS. 36 to 43 are perspective plan views of the mounting unit 11 and the body of the stand 10 for illustrating the operational situation of the monitor lock 33. Components unnecessary for description are omitted.

First, with reference to FIGS. 36 to 38, a case where the television receiver 21 is set on the mounting unit 11 will be described. FIG. 36 shows a state of the mounting unit 11 having the television receiver 21 mounted thereon being rearward pushed from the front of the stand 10.

In FIG. 36, since the mounting unit 11 has positioned at the front, the monitor lock 33 is now opening and protruding from the front surface of the mounting unit 11. During the forward moving of the mounting unit 11, the hooks 311 and 312 hang the flanges 324 and 323, respectively, so that the flanges 324 and 323 are closed. FIG. 36 shows the state in that the mounting unit 11 is rearward pushed as shown in arrow 411, and is lowered until the cam followers 344 and 364 touch the guide blocks 315 and 314, respectively. As mentioned above, the monitor lock 33 is opening. Namely, the flanges 323 and 324 are in the utmost closed state, so that they pass through inside the hooks 311 and 312 without touching them.

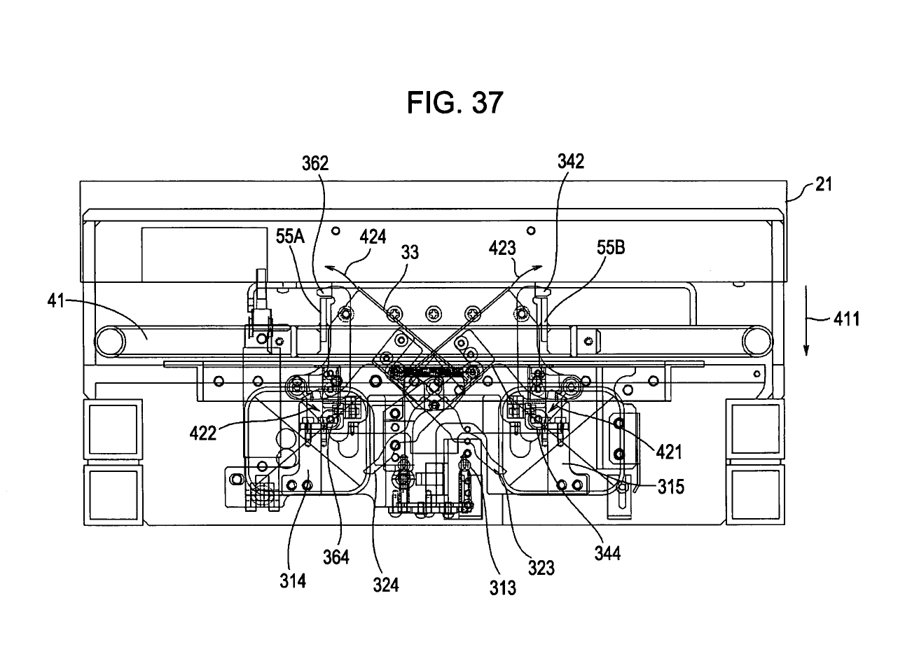

FIG. 37 shows the mounting unit 11 pushed further rearward than the state of FIG. 36. When the mounting unit 11 is pushed further than the state of FIG. 36, in the cam followers 344 and 364, trajectories of these cam followers, which have descended straight, are changed inward as shown in arrows 421 and 422 due to the inner side shapes of the guide blocks 315 and 314, respectively. Hence, as mentioned above, the hooks 342 and 362 protrude outside as shown in arrows 423 and 424 so as to lock (fix) the connection members 55B and 55A, respectively.

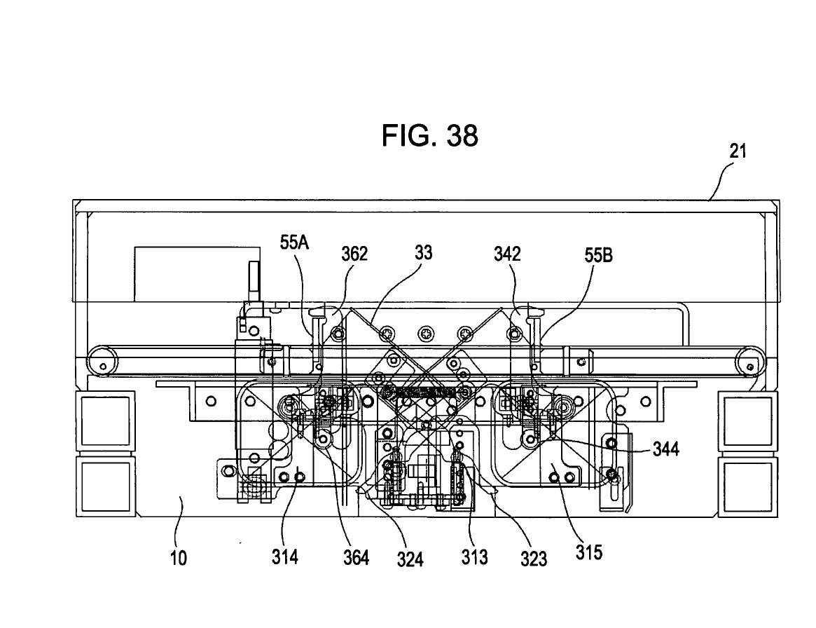

Then, when the mounting unit 11 pushed further rearward as shown in FIG. 38, the connection members 55B and 55A are perfectly fixed with the hooks 342 and 362, respectively. At this time, the television receiver 21 is fixed by the monitor hook 31 at the upper portion, and by the hooks 342 and 343 of the monitor lock 33 at the lower portion. Therefore, the mounting unit 11 can fix the television receiver 21 more stably.

When the television receiver 21 is mounted on the mounting unit 11, the connection members 55A and 55B and the monitor pipe 41 touch the body of the stand 10, so that the mounting unit 11 does not move down further more. Thus, the spring support 313 does not push back the flange 323 in this case, so that the monitor lock 33 is opened as it is also in FIG. 38.

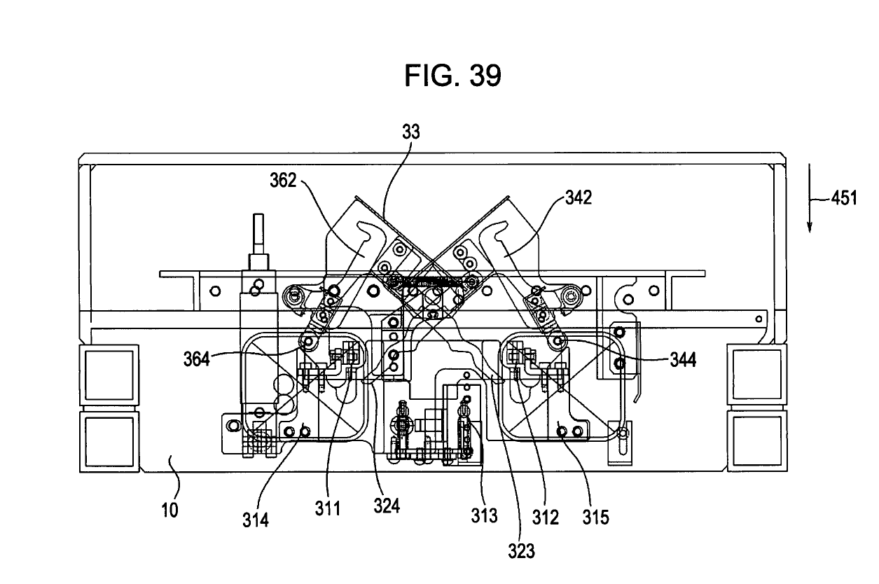

Then, with reference to FIGS. 39 to 43, a case where the television receiver 21 is not set on the mounting unit 11 will be described.

FIG. 39, in the same way as in FIG. 36, shows the state in that the mounting unit 11 without the television receiver 21 mounted thereon, which has been forward positioned, is rearward pushed as shown in arrow 451. In this case also, in the same way as in FIG. 36, the cam followers 344 and 364 are in contact with the guide blocks 315 and 314, respectively. As mentioned above, the monitor lock 33 is opening. Namely, the flanges 323 and 324 are in the utmost closed state, so that they pass through inside the hooks 311 and 312 without touching them. Up to this, the situation of the mounting unit 11 with the television receiver 21 mounted thereon is the same as that without the television receiver 21.

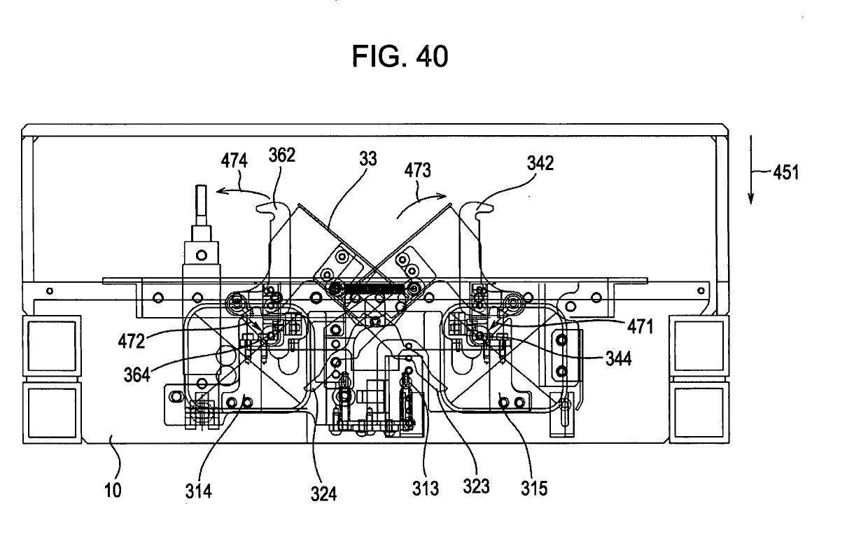

FIG. 40 shows the mounting unit 11 pushed further rearward than the state of FIG. 39. In FIG. 40, when the mounting unit 11 is pushed further than the state of FIG. 39, in the same way as in FIG. 37, the trajectories of the cam followers 344 and 364, which have descended straight, are changed inward as shown in arrows 471 and 472 due to the inner side shapes of the guide blocks 315 and 314, respectively. Hence, as mentioned above, the hooks 342 and 362 protrude outside as shown in arrows 473 and 474. However, the mounting unit 11 has not the television receiver 21 mounted thereon in this case, so that the protruded hooks 342 and 362 fix nothing.

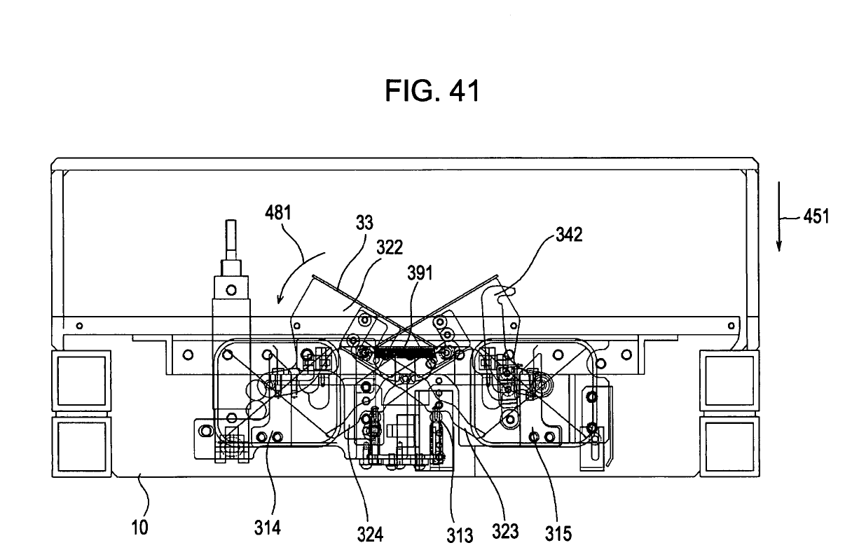

FIG. 41 shows the mounting unit 11 pushed further rearward than the state of FIG. 40. In FIG. 41, the television receiver 21 is not mounted on the mounting unit 11, so that the mounting unit 11 is pushed rearward further than the state of FIG. 38. At this time, if the flange 323 touches the spring support 313, the spring support 313 pushes back the flange 323 forward. Then, a force is applied to the flanges 323 and 324 to make them apart, and by this force, the right base plate 322 is rotated in a rearward closing direction as shown in arrow 481.

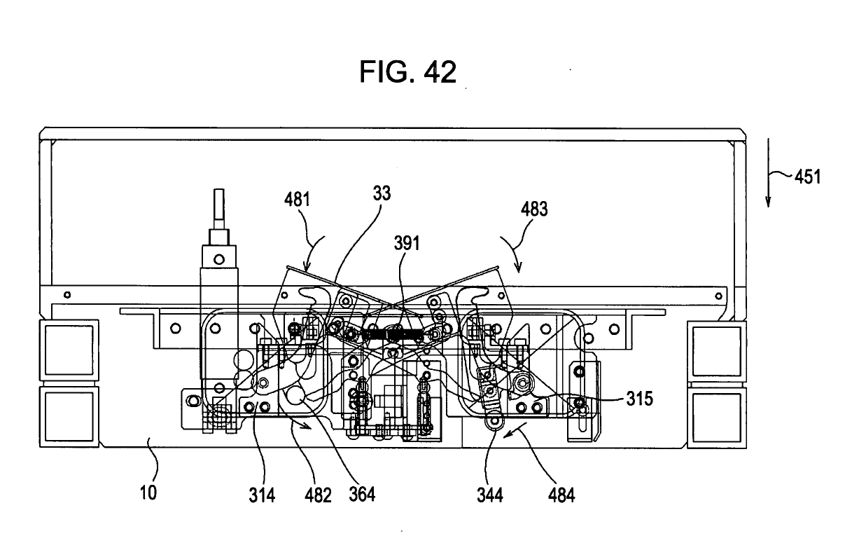

As shown in FIG. 42, by the rotational operation of the right base plate 322 in a rearward closing direction as shown in arrow 481, the cam follower 364 is separated from the side of the guide block 314 as shown in arrow 482. Then, the hook 362 is closed inside by the force of the spring 365.

When the flanges 323 and 324 open to some extent in such a manner, a pulling force is then applied thereto by the spring 391 in a further opening direction. By this force, the left base plate 321 is rotated in a rearward closing direction as shown in arrow 483. Along with this rotational operation, when the cam follower 344 is drawn inside as shown in arrow 484, the cam follower 344 is separated from the side of the guide block 315. Then, the hook 342 is closed inside by the force of the spring 345.

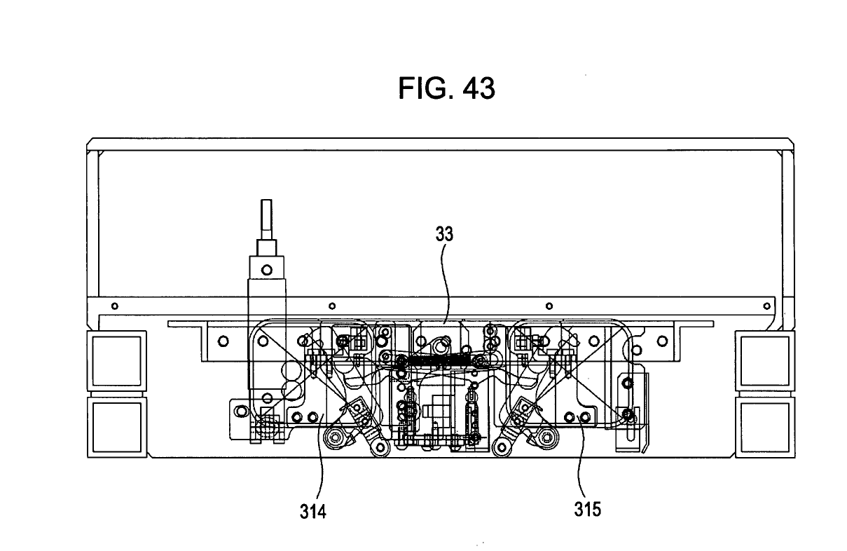

In such a manner, the right base plate 322 and the left base plate 321 are to be closed, and as shown in FIG. 43, the front-face panels 341 and 361 are finally closed in parallel with each other so as to form one plane as part of the front surface of the mounting unit 11, so that the monitor lock 33 is perfectly accommodated within the mounting unit 11.

In such a manner, the monitor lock 33, in the same way as in the monitor hook 31, can open and close only when necessary in accordance with the sliding operation of the mounting unit 11 in back and forth directions.

Also, the monitor hook 31 fixes the upper portion of the television receiver 21 in the vertical direction; whereas, the monitor lock 33 fixes the lower portion of the television receiver 21 in horizontal, back, and forth directions, so that the television receiver 21 can be mounted on the mounting unit 11 much more stably by these members.

By pulling/pushing the monitor lock 33 using wire, rubber, and a spring, the monitor lock 33 may be simply opened/closed corresponding to the operation of the mounting unit 11; however, the structure may be complicated, so that it is difficult to achieve it within a small space. It is also difficult to maintain much durability. Also, in this case, not only the manufacturing cost of the stand 10 may be increased but also a plurality of the television receivers 21 may not be arranged by bringing them close to each other.

Whereas, the monitor hook 31 mentioned above controls the hook to open/close with a simple structure by controlling the trajectory of the cam follower so as to achieve a durable locking mechanism with reduced manufacturing cost and a device scale.

Using such a monitor lock 33 to be arranged by saving a space, the stand 10 may achieve the mounting unit 11 described above so as to arrange a plurality of the television receivers 21 (monitors) so that a user may easily mount or remove an arbitrary arranged television receiver 21 (monitor).

In the above-description, the stand 10 may mount the nine television receivers 21; however, the number may be eight or less or ten or more. In these cases, the number of the mounting units 11 for the maximum television receivers 21 must be prepared.

The configuration described as one apparatus in this specification may be divided into a plurality of apparatuses. Conversely, the configuration described as a plurality of apparatuses may be combined into one apparatus. Also, a configuration other than the configuration described may be obviously added. Furthermore, as long as the configuration and operation are substantially the same as a whole apparatus, part of some configuration may be included in part of other configuration.

According to the embodiment of the present invention, a plurality of monitors can be mounted so that a user may easily mount or remove an arbitrary arranged monitor.

It should be understood by those skilled in the art that various modifications, combinations, sub-combinations and alterations may occur depending on design requirements and other factors insofar as they are within the scope of the appended claims or the equivalents thereof.

What is claimed is:

1. A mounting mechanism provided in a predetermined movable member for mounting an object on the member, comprising fixing means for fixing the object to the member in drivingly associated with a change in position of the member.

2. The mechanism according to claim 1, wherein the fixing means includes a hook with a hook-like end, and rotates the hook in drivingly associated with a change in position of the member so as to fix the object at a predetermined position using the hook-like shape of the hook end.

3. The mechanism according to claim 1, further comprising an immovable fixed member, wherein the member is connected to the fixed member with a pantograph mechanism therebetween so as to slide in back and forth directions relative to the fixed member within a movable range of the pantograph mechanism, and
wherein the fixing means changes the state of the object to be mountable when the member is forward slid, and it mounts the object arranged at a predetermined position on the member when the member is rearward slid.

4. The mechanism according to claim 3, wherein when the member is rearward slid, if the object is not arranged at a predetermined position, the fixing means is accommodated within the member.

5. A monitor mounting apparatus for stably mounting a monitor on a movable member, comprising;
a fixed member; and
the movable member movably connected to the fixed member,
wherein the movable member includes monitor fixing means for fixing the monitor to the movable member in drivingly associated with a change in position of the movable member relative to the fixed member.

6. A mounting mechanism provided in a predetermined movable member for mounting an object on the member, comprising a fixing unit configured to fix the object to the member in drivingly associated with a change in position of the member,
wherein the fixing unit is configured to have a hook with a hook-like end and to rotate the hook in drivingly associated with a change in position of the member so as to fix the object at a predetermined position using the hook-like shape of the hook end.
